(19) United States
(12) Patent Application Publication
(10) Pub. No.: US 2015/0245168 A1
(43) Pub. Date: Aug. 27, 2015

(54) SYSTEMS, DEVICES AND METHODS FOR LOCATION-BASED SOCIAL NETWORKS

(71) Applicant: Flock Inc., Lake Tapps, WA (US)

(72) Inventor: Jordan Ari Martin, Lake Tapps, WA (US)

(21) Appl. No.: 14/190,022

(22) Filed: Feb. 25, 2014

(51) Int. Cl. H04W 4/02; H04L 29/08; G06T 11/60; G06F 3/0484

(52) U.S. Cl. CPC H04W 4/02; G06F 3/04842; H04L 67/18; G06T 11/60

(57) ABSTRACT

Global Positioning System (GPS) data and/or functionality of various users' mobile devices may be used to enable the users to share with their friends or contacts their current location in real time or near real time. There may be an individual graphical marker for each user that is presented on a map corresponding to the current location of the user's device. The graphical marker may represent an online social network identity of the user. This interactive graphical marker is presented at a location on the map corresponding to the current physical location of the user's device based on the associated GPS data and/or other location data. If the location of the device moves, this is shown on the map by the associated graphical marker making corresponding movements on the map. A user may set a beacon on the map at a location at which an event is to occur and connections or friends of the user will be sent information indicative of the location on the map and associated GPS directions. The user can select any associated graphical marker on the map and receive information or video chat and/or messaging services related to the user whose online social network identity is represented by the graphical marker.

### BRIEF SUMMARY

A method performed by at least one machine for facilitating location-based social networks may be summarized as including: electronically receiving, by at least one communications component of the at least one machine for facilitating location-based social networks, information regarding a current physical location of a device of at least one member of an online social network; electronically presenting, by at least one processor of the at least one machine for facilitating location-based social networks, a map on a graphical user interface; electronically presenting on the map presented on the graphical user interface, by at least one processor of the at least one machine for facilitating location-based social networks, an interactive graphical marker at a location on the map corresponding to the current physical location of the device based on the received information regarding the current physical location of the device, the interactive graphical marker representative of an online social network identity of the at least one member; electronically receiving, by at least one processor of the at least one machine for facilitating location-based social networks, an indication that a user has selected the interactive marker on the map presented on the graphical user interface; and in response to the receiving the indication that the user has selected the interactive marker, electronically providing to the user, by at least one processor of the at least one machine for facilitating location-based social networks, information associated with the at least one member of the online social network.

The method may further include: moving, by at least one processor of the at least one machine for facilitating location-based social networks, the interactive marker on the map presented on the graphical user interface in substantially real time as corresponding updated information is received by the at least one communications component regarding a new current physical location of the device of the at least one member of the online social network, wherein the interactive marker is displayed on the map by at least one processor as the interactive marker moves. The corresponding updated information received by the at least one communications component may be based on global positioning system (GPS) information regarding a current location of the device of the at least one member of the online social network. The method may further include: in response to the receiving the indication that the user has selected the interactive marker presented on the map, initiating activation of an online video conference session between the user and the at least one member. The initiating activation of the online video conference session may include: graphically transforming the interactive marker presented on the map to an online video conference session window located on the map at the location of the interactive marker on the map. The indication that the user has selected the interactive marker presented on the map may be an indication that the user has touched a location on a touch screen at which the interactive marker is presented. The method may further include: electronically receiving, by at least one communications component of the at least one machine for facilitating location-based social networks, information regarding current physical locations of a plurality of devices, each of the plurality of devices associated with a corresponding one of a plurality of members of an online social network; and for each of the plurality of devices, electronically presenting on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network. The method may further include: electronically receiving, by at least one processor of the at least one machine for facilitating location-based social networks, one or more indications that a user has selected multiple interactive markers presented on the map, the selected interactive markers representative of different online social network identities of corresponding members of the online social network; and in response to the receiving the one or more indications that the user has selected multiple interactive markers presented on the map, initiating activation of a group online video conference session including the user and the corresponding members of the online social network of which the selected interactive markers are representative. The interactive graphical marker may include an image of the at least one member of which the interactive graphical marker is representative. The method may further include: electronically receiving, by at least one communications component of the at least one machine for facilitating location-based social networks, an indication that a user has selected to zoom in on the map presented on the graphical user interface; and in response to the received indication that the user has selected to zoom in on the map presented on the graphical user interface, electronically presenting, by at least one processor of the at least one machine for facilitating location-based social networks, an enlarged section of the map on the graphical user interface including a plurality of interactive graphical markers on the enlarged section of the map, each interactive graphical marker of the plurality of interactive graphical markers being at a location on the enlarged section of the map corresponding to a physical location of a corresponding device of a member of the online social network identified by the interactive graphical marker. The method may further include: electronically receiving, by at least one communications component of the at least one machine for facilitating location-based social networks, an indication that a user has selected to zoom out on the map presented on the graphical user interface; and in response to the received indication that the user has selected to zoom out on the map presented on the graphical user interface, electronically presenting, by at least one processor of the at least one machine for facilitating location-based social networks, a zoomed-out version of the map presented on the graphical user interface including additional surrounding area and an additional plurality of interactive graphical markers on the zoomed-out version of the map, each interactive graphical marker of the additional plurality of interactive graphical markers being shown at a location in the surrounding area on the zoomed-out version of the map corresponding to a physical location of a corresponding device of a member of the online social network identified by the interactive graphical marker. The information associated with the at least one member of the online social network that is provided to the user in response to the receiving the indication that the user has selected the interactive marker may include online social network profile information of the member of the online social network. The information associated with the at least one member of the online social network that is provided to the user in response to the receiving the indication that the user has selected the interactive marker may include information enabling the user to communicate with the member of the online social network.

A system for facilitating location-based social networks may be summarized as including: at least one communications component of at least one machine for facilitating location-based social networks that receives information regarding a current physical location of a device of at least one member of an online social network; at least one processor coupled to the at least one communications component; and at least one non-transitory computer-readable storage medium coupled to the at least one processor, the at least one non-transitory computer readable storage medium having computer executable instructions stored thereon that, when executed by the at least one processor, cause the at least one processor to: electronically present a map on a graphical user interface; electronically present on the map presented on the graphical user interface an interactive graphical marker at a location on the map corresponding to the current physical location of the device based on received information regarding the current physical location of the device, the interactive graphical marker representative of an online social network identity of the at least one member; be able to electronically receive an indication that a user has selected the interactive marker on the map presented on the graphical user interface; and in response to the receiving the indication that the user has selected the interactive marker, electronically provide to the user services associated with the at least one member of the online social network.

The computer executable instructions, when executed by the at least one processor, may further cause the at least one processor to: move the interactive marker on the map presented on the graphical user interface in substantially real time as corresponding updated information is received by the at least one communications component regarding a new current physical location of the device of the at least one member of the online social network, wherein the computer executable instructions, when executed by the at least one processor, may further cause the at least one processor to display the interactive marker on the map as the interactive marker moves. The received corresponding updated information may be based on global positioning system (GPS) information regarding a current location of the device of the at least one member of the online social network. The computer executable instructions, when executed by the at least one processor, may further cause the at least one processor to: in response to the receiving the indication that the user has selected the interactive marker presented on the map, cause an initiation of an online video conference session between the user and the at least one member. The initiation of the online video conference session may include a graphical transformation of the interactive marker presented on the map to an online video conference session window located on the map at the location of the interactive marker on the map. The indication that the user has selected the interactive marker presented on the map may be an indication that the user has touched a location on a touch screen at which the interactive marker is presented. The computer executable instructions, when executed by the at least one processor, may further cause the at least one processor to: cause the at least one communications component to electronically be able to receive information regarding current physical locations of a plurality of devices, each of the plurality of devices associated with a corresponding one of a plurality of members of an online social network; and for each of the plurality of devices, electronically present on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network. The computer executable instructions, when executed by the at least one processor, may further cause the at least one processor to: electronically be able to receive one or more indications that a user has selected multiple interactive markers presented on the map, the selected interactive markers representative of different online social network identities of corresponding members of the online social network; and in response to the receiving the one or more indications that the user has selected multiple interactive markers presented on the map, initiate a group online video conference session including the user and the corresponding members of the online social network of which the selected interactive markers are representative. The interactive graphical marker may include an image of the at least one member of which the interactive graphical marker is representative. The computer executable instructions, when executed by the at least one processor, may further cause the at least one processor to: cause the at least one communications component to electronically be able to receive an indication that a user has selected to zoom in on the map presented on the graphical user interface; and in response to the received indication that the user has selected to zoom in on the map presented on the graphical user interface, electronically present an enlarged section of the map on the graphical user interface including a plurality of interactive graphical markers on the enlarged section of the map, each interactive graphical marker of the plurality of interactive graphical markers being at a location on the enlarged section of the map corresponding to a physical location of a corresponding device of a member of the online social network identified by the interactive graphical marker. The computer executable instructions, when executed by the at least one processor, may further cause the at least one processor to: electronically be able to receive an indication that a user has selected to zoom out on the map presented on the graphical user interface; and in response to the received indication that the user has selected to zoom out on the map presented on the graphical user interface, electronically present a zoomed-out version of the map presented on the graphical user interface including additional surrounding area and an additional plurality of interactive graphical markers on the zoomed-out version of the map, each interactive graphical marker of the additional plurality of interactive graphical markers being shown at a location in the surrounding area on the zoomed-out version of the map corresponding to a physical location of a corresponding device of a member of the online social network identified by the interactive graphical marker. The services associated with the at least one member of the online social network that is provided to the user in response to the receiving the indication that the user has selected the interactive marker may include communications services for communication with the member of the online social network by the user. The services associated with the at least one member of the online social network that is provided to the user in response to the receiving the indication that the user has selected the interactive marker may include selection of the member of the online social network for inclusion in a subgroup of members of the online social network.

A non-transitory computer-readable storage medium may be summarized as including computer-executable instructions stored thereon that, when executed by at least one processor of a computer system, causes the at least one computer system to: electronically present a map on a graphical user interface of the computer system; electronically present on the map presented on the graphical user interface an interactive graphical marker at a location on the map corresponding to a current physical location of a device of at least one member of an online social network based on received information regarding the current physical location of the device, the interactive graphical marker representative of an online social network identity of the at least one member; and move the interactive marker on the map presented on the graphical user interface in substantially real time as corresponding updated information is received regarding a new current physical location of the device of the at least one member of the online social network, wherein the computer executable instructions, when executed by the at least one processor, further cause the at least one processor to display the interactive marker on the map as the interactive marker moves.

The computer system may be a mobile device. The received corresponding updated information may be based on global positioning system (GPS) information regarding a current location of the device of the at least one member of the online social network. The computer executable instructions, when executed by the at least one processor, may further cause the at least one processor to: in response to the receiving an indication that a user has selected the interactive marker presented on the map, cause an initiation of an online video conference session between the user and the at least one member.

A method performed by at least one machine for facilitating location-based social networks may be summarized as including: electronically presenting to a user, by at least one processor of the at least one machine for facilitating location-based social networks, a map on a graphical user interface; electronically receiving, by at least one processor of the at least one machine for facilitating location-based social networks, information indicative of a location on the map selected by the user at which an event is to occur; and electronically communicating, by the at least one processor of the at least one machine for facilitating location-based social networks, information indicative of the selected location to a plurality of members of an online social network.

The electronically communicating information indicative of the selected location to a plurality of members of the online social network may be in response to the receiving the information indicative of a location on the map selected by the user at which the event is to occur. The electronically communicating information indicative of the location to a plurality of members of an online social network may include: selecting, by the at least one processor, the plurality of members of the online social network to whom to communicate the information indicative of the location based on individual associations between the user and the plurality of members as defined in an account of the user on the online social network. The selecting the plurality of members may include: determining, by the at least one processor, members of the online social network who are friends of the user as defined in the account of the user on the online social network; and electronically communicating, by the at least one processor of the at least one machine for facilitating location-based social networks, the information indicative of the selected location to the members determined to be friends of the user. The method may further include: in response to the receiving the information indicative of the location on the map selected by the user at which the event is to occur, electronically presenting to the user, by at least one processor of the at least one machine for facilitating location-based social networks, a menu enabling the user to select the plurality of members of the online social network to whom the information indicative of the location is to be communicated. The method may further include: electronically presenting on the map presented on the graphical user interface, by at least one processor of the at least one machine for facilitating location-based social networks, a graphical marker at a location on the map corresponding to the location on the map selected by the user at which an event is to occur. The method may further include: electronically receiving, by at least one communications component of the at least one machine for facilitating location-based social networks, information regarding current physical locations of a plurality of devices, each of the plurality of devices associated with a corresponding member of the plurality of members of the online social network to whom the information indicative of the location had been communicated; and for each device of the plurality of devices, electronically presenting on the map presented on the graphical user interface, by at least one processor of the at least one machine for facilitating location-based social networks, a graphical marker at a location on the map corresponding to a current physical location of the device based on the received information regarding the current physical locations of the plurality of devices, the graphical marker representative of an online social network identity of the corresponding member of the online social network associated with the device. The method may further include: for each device of the plurality of devices, updating a location on the map of the graphical marker corresponding to a current physical location of the device in substantially real time as corresponding updated information is received regarding the current physical locations of the plurality of devices. The method may further include: for each device of the plurality of devices, showing a path on the map that the device is travelling substantially in real time as corresponding updated information is received regarding the current physical locations of the plurality of devices. The at least one of the plurality of devices may be a mobile communications device or a vehicle. The electronically communicating information indicative of the location to a plurality of members of an online social network may include: being able to receive input indicative of a selection of an area on the map by the user; and selecting, by the at least one processor, each member of the online social network for which an associated graphical marker representative of the online social network identity of the member is on the map and falls within the selected area as one of the plurality of members of the online social network to whom to communicate the information indicative of the location. The method may further include: in response to the electronically receiving the information indicative of the location on the map selected by the user at which an event is to occur, electronically presenting on the map, by at least one processor of the at least one machine for facilitating location-based social networks, a menu located on or next to the graphical marker on the map enabling the user to provide information regarding the event including one or more of: a written description of the event, a voice-recorded description of the event and a video description of the event; and electronically communicating, by the at least one processor of the at least one machine for facilitating location-based social networks, the information regarding the event to the plurality of members of the online social network. The menu located on or next to the graphical marker on the map may include a menu selection enabling the user to activate the communicating of the information indicative of the selected location to the plurality of members of the online social network. The menu located on or next to the graphical marker on the map may include a menu selection enabling the user to set a desired meeting time for the event. The method may further include: receiving information indicative of a selection by the user of the menu selection enabling the user to activate the communicating of the information indicative of the selected location, wherein the electronically communicating information indicative of the selected location to the plurality of members of the online social network is in response to the receiving the information indicative of the selection by the user of the menu selection enabling the user to activate the communicating of the information indicative of the selected location. The method may further include: in response to receiving the information indicative of the selection by the user of the menu selection enabling the user to activate the communicating of the information indicative of the selected location, electronically communicating, by the at least one processor of the at least one machine for facilitating location-based social networks, the desired meeting time for the event to the plurality of members of the online social network. The information indicative of the selected location communicated to the plurality of members of the online social network may include directions to the selected location. The information indicative of the selected location communicated to the plurality of members of the online social network may include global positioning system (GPS) coordinates of the selected location. The information indicative of the selected location communicated to the plurality of members of the online social network may include a link which, when selected, activates one or more navigation systems to provide navigation particularly to the selected location for one or more of the plurality of members. The information indicative of the selected location communicated to the plurality of members of the online social network may include one or more of a written description of the event, a voice-recorded description of the event, and a video description of the event. The method may further include: before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by enabling the user to indicate a point on the map indicative of the location on the map at which an event is to occur. The menu enabling the user to indicate a point on the map may include enabling the user to be able to touch a desired point on the map corresponding to the point on the map at which an event is to occur. The method may further include: before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by providing an option to the user to indicate a selection to tie the location on the map at which an event is to occur to a current location of a device of the user; and tying the location on the map at which an event is to occur to a current location of a device of the user based on the selection to tie the location on the map at which an event is to occur to the current location of the device of the user. The method may further include: before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by enabling the user to indicate a point on the map by providing an option to the user to tie the location on the map at which an event is to occur to a current location of a particular device. The method may further include: receiving updated information regarding the current location of the particular device; and updating the location on the map at which an event is to occur substantially in real time as the updated information regarding the current location of the particular device is received.

A system for facilitating location-based social networks may be summarized as including: at least one communications component of at least one machine for facilitating location-based social networks; at least one processor coupled to the at least one communications component; and at least one non-transitory computer-readable storage medium coupled to the at least one processor, the at least one non-transitory computer readable storage medium having computer executable instructions stored thereon that, when executed by the at least one processor, cause the at least one processor to: electronically present to a user a map on a graphical user interface; be able to electronically receive information indicative of a location on the map selected by the user at which an event is to occur; and cause the at least one communications component to electronically communicate information indicative of the selected location to a plurality of members of an online social network.

The computer executable instructions, when executed by the at least one processor, may cause the at least one processor to: cause the at least one communications component to electronically communicate the information indicative of the selected location to the plurality of members of the online social network is in response to the receiving of the information indicative of the location on the map selected by the user at which the event is to occur. The computer executable instructions, when executed by the at least one processor, may further cause the at least one processor to: select the plurality of members of the online social network to whom to communicate the information indicative of the location to based on individual associations between the user and the plurality of members as defined in an account of the user on the online social network. The selecting the plurality of members may include: determining members of the online social network who are friends of the user as defined in the account of the user on the online social network; and electronically communicating the information indicative of the selected location to the members determined to be friends of the user.

A non-transitory computer-readable storage medium may be summarized as including computer-executable instructions stored thereon that, when executed by at least one processor of a computer system, cause the computer system to: electronically present to a user a map on a graphical user interface; be able to electronically receive information indicative of a location on the map selected by the user at which an event is to occur; and cause the at least one communications component to electronically communicate information indicative of the selected location to a plurality of members of an online social network.

The computer executable instructions, when executed by the at least one processor, may further cause the at least one processor to: in response to the receiving the information indicative of the location on the map selected by the user at which the event is to occur, electronically present to the user, by at least one processor of the at least one machine for facilitating location-based social networks, a menu enabling the user to select the plurality of members of the online social network to whom the information indicative of the location is to be communicated. The computer executable instructions, when executed by the at least one processor, may further cause the at least one processor to: electronically present on the map presented on the graphical user interface, by at least one processor of the at least one machine for facilitating location-based social networks, a graphical marker at a location on the map corresponding to the location on the map selected by the user at which the event is to occur. The computer executable instructions, when executed by the at least one processor, may further cause the at least one processor to: be able to electronically receive information regarding current physical locations of a plurality of devices, each of the plurality of devices associated with a corresponding member of the plurality of members of the online social network to whom the information indicative of the location had been communicated; and for each device of the plurality of devices, electronically present on the map presented on the graphical user interface a graphical marker at a location on the map corresponding to a current physical location of the device based on the received information regarding the current physical locations of the plurality of devices, the graphical marker representative of an online social network identity of the corresponding member of the online social network associated with the device.

A method performed by at least one machine for facilitating location-based social networks may be summarized as including: electronically receiving, by at least one processor of the at least one machine for facilitating location-based social networks, input from a user including selection criteria; electronically determining, by at least one processor of the at least one machine for facilitating location-based social networks, one or more members of an online social network based on the selection criteria; and in response to the electronically determining the one or more members of the online social network based on the selection criteria, for each of the determined one or more members, electronically presenting on a map presented on a graphical user interface, by at least one processor of the at least one machine for facilitating location-based social networks, an interactive graphical marker at a location on the map corresponding to a current physical location of a device associated with the member, the interactive graphical marker representative of an online social network identity of the member of the online social network.

The selection criteria may be based on voice recorded input from the user. The selection criteria may include one or more of: a name, online social network member identification, an email address, a phone number, online social network member profile information, likes of one or more members of the online social network, activities of one or more members of the online social network, events that one or more members of the online social network had attended, and interests of one or more members of the online social network. The selection criteria may include an inquiry input from the user and the determining the one or more members of the online social network based on the selection criteria includes determining the one or more members of the online social network based on determining which members of the online social network have input similar inquiries. The determining the one or more members of the online social network based on the selection criteria may include obtaining data originating from one or more online social network accounts on one or more other online social networks of the one or more users. The electronically determining one or more members of the online social network based on the selection criteria may include determining the one or more members of the online social network additionally based on individual associations between the user and the one or more of members as defined in an account of the user on the online social network.

A system for facilitating location-based social networks may be summarized as including: at least one communications component of at least one machine for facilitating location-based social networks; at least one processor coupled to the at least one communications component; and at least one non-transitory computer-readable storage medium coupled to the at least one processor, the at least one non-transitory computer readable storage medium having computer executable instructions stored thereon that, when executed by the at least one processor, cause the at least one processor to: be able to electronically receive input from a user including selection criteria; electronically determine one or more members of an online social network based on the selection criteria; and in response to the determination of the one or more members of the online social network based on the selection criteria, for each of the determined one or more members, electronically present on a map presented on a graphical user interface an interactive graphical marker at a location on the map corresponding to a current physical location of a device associated with the member, the interactive graphical marker representative of an online social network identity of the member of the online social network.

The selection criteria may include an inquiry input from the user and the determining the one or more members of the online social network based on the selection criteria may include determining the one or more members of the online social network based on determining which members of the online social network have input similar inquiries. The determining the one or more members of the online social network based on the selection criteria may include obtaining data originating from one or more online social network accounts on one or more other online social networks of the one or more users. The electronically determining one or more members of the online social network based on the selection criteria may include determining the one or more members of the online social network additionally based on individual associations between the user and the one or more of members as defined in an account of the user on the online social network.

A non-transitory computer-readable storage medium may be summarized as including computer-executable instructions stored thereon that, when executed by at least one processor of a computer system, cause the computer system to: be able to electronically receive input from a user including selection criteria; electronically determine one or more members of an online social network based on the selection criteria; and in response to the determination of the one or more members of the online social network based on the selection criteria, for each of the determined one or more members, electronically present on a map presented on a graphical user interface an interactive graphical marker at a location on the map corresponding to a current physical location of a device associated with the member, the interactive graphical marker representative of an online social network identity of the member of the online social network.

The selection criteria may include an inquiry input from the user and the determining the one or more members of the online social network based on the selection criteria includes determining the one or more members of the online social network based on determining which members of the online social network have input similar inquiries. The determining the one or more members of the online social network based on the selection criteria may include obtaining data originating from one or more online social network accounts on one or more other online social networks of the one or more users. The electronically determining one or more members of the online social network based on the selection criteria may include determining the one or more members of the online social network additionally based on individual associations between the user and the one or more of members as defined in an account of the user on the online social network.

A method performed by at least one machine for facilitating location-based social networks may be summarized as including: electronically obtaining, by at least one processor of the at least one machine for facilitating location-based social networks, information regarding one or more social network accounts of a first member of an online social network; electronically obtaining, by at least one processor of the at least one machine for facilitating location-based social networks, information regarding one or more social network accounts of one or more other members of the online social network; electronically comparing, by at least one processor of the at least one machine for facilitating location-based social networks, the information regarding the one or more social network accounts of the first member of the online social network and the information regarding the one or more social network accounts of the one or more other members of the online social network; electronically associating, by at least one processor of the at least one machine for facilitating location-based social networks, the first member of the online social network with one of the one or more other members of the online social network based on the comparison; electronically selecting, by at least one processor of the at least one machine for facilitating location-based social networks, a physical location for the first member of the online social network and the one of the one or more other members of the online social network to meet at; and electronically communicating, by the at least one processor of the at least one machine for facilitating location-based social networks, information indicative of the selected location to the first member of the online social network and to the one of the one or more other members of the online social network.

The electronically communicating information indicative of the selected location may include: causing a presentation on a map on a graphical user interface, by at least one processor of the at least one machine for facilitating location-based social networks, a graphical marker at a location on the map corresponding to the selected location. The information indicative of the selected location may include global positioning system (GPS) coordinates of the selected location. The information indicative of the selected location may include a link which, when selected, activates one or more navigation systems to provide navigation particularly to the selected location for the first member of the online social network and the one of the one or more other members of the online social network. The method may further include: electronically communicating, by the at least one processor of the at least one machine for facilitating location-based social networks, information indicative of one or more alternative physical meeting locations to at least one of the first member of the online social network and to the one of the one or more other members of the online social network; receiving, by the at least one processor of the at least one machine for facilitating location-based social networks, an indication of a selected alternative physical meeting location of the one or more alternative physical meeting locations; and electronically communicating, by the at least one processor of the at least one machine for facilitating location-based social networks, information indicative of the selected location to the first member of the online social network and to the one of the one or more other members of the online social network. The electronically selecting the physical location for the first member of the online social network and the one of the one or more other members of the online social network to meet may be based on current physical locations of the first member of the online social network and the one of the one or more other members of the online social network. The electronically selecting the physical location for the first member of the online social network and the one of the one or more other members of the online social network to meet may be based on compensation received for selection of one or more locations. The electronically selecting the physical location for the first member of the online social network and the one of the one or more other members of the online social network to meet may be based on the comparing of the information regarding the one or more social network accounts of the first member of the online social network and the information regarding the one or more social network accounts of the one or more other members of the online social network, wherein the comparing includes comparing one or more of: online social network member profile information, likes of one or more members of the online social network, activities of one or more members of the online social network, events that one or more members of the online social network had attended, and interests of one or more members of the online social network.

A system for facilitating location-based social networks may be summarized as including: at least one communications component of at least one machine for facilitating location-based social networks; at least one processor coupled to the at least one communications component; and at least one non-transitory computer-readable storage medium coupled to the at least one processor, the at least one non-transitory computer readable storage medium having computer executable instructions stored thereon that, when executed by the at least one processor, cause the at least one processor to: electronically obtain information regarding one or more social network accounts of a first member of an online social network; electronically obtain information regarding one or more social network accounts of one or more other members of the online social network; electronically compare the information regarding the one or more social network accounts of the first member of the online social network and the information regarding the one or more social network accounts of the one or more other members of the online social network; electronically associate the first member of the online social network with one of the one or more other members of the online social network based on the comparison; electronically select a physical location for the first member of the online social network and the one of the one or more other members of the online social network to meet at; and electronically communicate information indicative of the selected location to the first member of the online social network and to the one of the one or more other members of the online social network.

The electronically communicating information indicative of the selected location may include: causing presentation on a map on a graphical user interface of a graphical marker at a location on the map corresponding to the selected location. The information indicative of the selected location may include global positioning system (GPS) coordinates of the selected location.

A non-transitory computer-readable storage medium may be summarized as including computer-executable instructions stored thereon that, when executed by at least one processor of a computer system, cause the computer system to: electronically obtain information regarding one or more social network accounts of a first member of an online social network; electronically obtain information regarding one or more social network accounts of one or more other members of the online social network; electronically compare the information regarding the one or more social network accounts of the first member of the online social network and the information regarding the one or more social network accounts of the one or more other members of the online social network; electronically associate the first member of the online social network with one of the one or more other members of the online social network based on the comparison; electronically select a physical location for the first member of the online social network and the one of the one or more other members of the online social network to meet at; and electronically communicate information indicative of the selected location to the first member of the online social network and to the one of the one or more other members of the online social network.

The electronically communicating information indicative of the selected location may include: causing a presentation on a map on a graphical user interface a graphical marker at a location on the map corresponding to the selected location. The information indicative of the selected location may include global positioning system (GPS) coordinates of the selected location.

A method performed by at least one machine for facilitating location-based social networks may be summarized as including: electronically receiving, by at least one communications component of the at least one machine for facilitating location-based social networks, information regarding current physical locations of a plurality of devices, each of the plurality of devices associated with a corresponding one of a plurality of members of an online social network; electronically presenting, by at least one processor of the at least one machine for facilitating location-based social networks, a map on a graphical user interface; and for each of the plurality of devices: electronically presenting on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network; and moving, by at least one processor of the at least one machine for facilitating location-based social networks, the interactive marker on the map presented on the graphical user interface based on corresponding updated information received by the at least one communications component regarding a new current physical location of the device.

The method may further include: electronically executing, by at least one processor of the at least one machine for facilitating location-based social networks, at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network. The corresponding updated information received by the at least one communications component may be based on global positioning system (GPS) information regarding current physical locations of the plurality of devices. Each device of the plurality of devices may be a mobile device. The plurality of members of the online social network may be a subset of all current members of the online social network.

A system for facilitating location-based social networks may be summarized as including: at least one communications component of at least one machine for facilitating location-based social networks; at least one processor coupled to the at least one communications component; and at least one non-transitory computer-readable storage medium coupled to the at least one processor, the at least one non-transitory computer readable storage medium having computer executable instructions stored thereon that, when executed by the at least one processor, cause the at least one processor to: be able to electronically receive information regarding current physical locations of a plurality of devices, each of the plurality of devices associated with a corresponding one of a plurality of members of an online social network; electronically present a map on a graphical user interface; and for each of the plurality of devices: electronically present on the map presented on the graphical user interface an interactive graphical marker at a location on the map corresponding to a current physical location of the device based on the received information regarding the current physical locations of the plurality of devices, the graphical marker representative of an online social network identity of the corresponding member of the online social network; and move the interactive marker on the map presented on the graphical user interface in substantially real time as corresponding updated information is received by the at least one communications component regarding a new current physical location of the device, wherein the interactive marker is displayed on the map as the interactive marker moves.

The computer executable instructions, when executed by the at least one processor, may further cause the at least one processor to: electronically execute at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network. The received corresponding updated information may be based on global positioning system (GPS) information regarding current physical locations of the plurality of devices. Each device of the plurality of devices may be a mobile device.

A non-transitory computer-readable storage medium may be summarized as including computer-executable instructions stored thereon that, when executed by at least one processor of a computer system, cause the computer system to: be able to receive information regarding current physical locations of a plurality of devices, each device of the plurality of devices associated with a corresponding one of a plurality of members of an online social network; present a map on a graphical user interface; and for each of the plurality of devices: present on the map presented on the graphical user interface a graphical marker at a location on the map corresponding to a current physical location of the device based on the received information regarding the current physical locations of the plurality of devices, the graphical marker representative of an online social network identity of the corresponding member of the online social network; and move the graphical marker on the map presented on the graphical user interface as corresponding updated information is received regarding a new current physical location of the device.

The computer executable instructions, when executed by the at least one processor, may further cause the computer system to: electronically execute at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network. The received corresponding updated information may be based on global positioning system (GPS) information regarding current physical locations of the plurality of devices. 104. Each device of the plurality of devices may be a mobile device. The computer executable instructions, when executed by the at least one processor, may further cause the computer system to: present on the map a marker expandable by a user; and be able to receive input indicative of expansion or contraction of the marker by the user; expand or contract the marker on the map according to the received input indicative of expansion or contraction; and broadcast a message to each member of the online social network for which an associated graphical marker representative of the online social network identity of the member is on the map and falls within the marker. The marker expandable by the user may be circular or rectangular. The computer executable instructions, when executed by the at least one processor, may further cause the computer system to: present on the graphical user interface a matrix of profile images each representative of an online social network identity of a member of the online social network associated with the user; be able to receive input indicative of selection by the user of one or more of the profile images in the matrix; and cause communication to occur with each member of the online social network for which the one or more of the profile images in the matrix was selected based on the received input indicative of the selection by the user of the one or more of the profile images in the matrix. The computer executable instructions, when executed by the at least one processor, may further cause the computer system to: be able to receive input indicative of selection regarding a visibility setting; and set a preference regarding whether a graphical marker presentable at a location on a map on a graphical user interfaces of devices of other members of the online social network is to be presented on the map on the graphical user interfaces of devices of the one or more other members of the online social network based on one or more criteria. The one or more criteria may be regarding one or more of: a threshold distance between a device of the user and the devices of the one or more members of the online social network; an association between the one or more members of the online social network and the user as defined in a user account of the user of the online social network; and a reciprocal preference setting regarding visibility as defined in a user account of the one or more members of the online social network. The computer executable instructions, when executed by the at least one processor, may further cause the computer system to: provide a notification to the user when one or more other members of the online social network associated with the user is within a particular distance from the user; and communicate to the user information indicative of a suggested location at which the user and the one or more other members associated with the user can meet. The communicating to the user information indicative of a suggested location may include: presenting on the map presented on the graphical user interface a graphical marker at a location on the map corresponding to the suggested location. The computer executable instructions, when executed by the at least one processor, may further cause the computer system to: communicate to the user an incentive to go to the suggested location. The computer executable instructions, when executed by the at least one processor, may further cause the computer system to: be able to receive input indicative of a selection by the user to follow a selected member of the online social network for which a graphical marker is displayed at a location on the map corresponding to a current physical location of a device of the selected member; and move the map on the graphical user interface to make the graphical marker displayed at the location on the map corresponding to the current physical location of the device of the selected member stay in view on the graphical user interface substantially in real time as updated information is received regarding a new current physical location of the device of the selected member of the online social network. The computer executable instructions, when executed by the at least one processor, may further cause the computer system to receive information indicative of a location on the map selected by a user at which an event is to occur; and in response to receiving the information indicative of the location, communicate information indicative of the selected location to the plurality of members of the online social network. The computer executable instructions, when executed by the at least one processor, may further cause the computer system to: be able to receive user input indicative of a marking to be made on the map; present on the map a marking corresponding to the input indicative of the marking to be made on the map; and communicate information regarding the marking to enable corresponding markings to be presented on corresponding maps on graphical user interfaces of devices of one or more of the plurality of members of the online social network.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a system diagram of a networked environment, in which systems, devices and methods for facilitating location-based social networks may be a part, or in which they may be implemented, according to one illustrated embodiment.

FIG. 2 is a schematic diagram of an example computer system of the server machine for facilitating location-based social networks and/or the user computer of FIG. 1, suitable for implementing systems, devices and methods for facilitating location-based social networks, according to one illustrated embodiment.

FIG. 3 is a schematic view of one of the mobile devices of FIG. 1, shown in more detail according to one illustrated embodiment, the mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), and a power source.

FIG. 4 is a block diagram representing example system architecture of a system for facilitating location-based social networks, according to one illustrated embodiment.

FIG. 5 is a drawing of an example user interface screen of a software application of a system for facilitating location-based social networks showing a location on a globe selected by a user, according to one illustrated embodiment.

FIG. 6 is a drawing of an example user interface screen of a software application of a system for facilitating location-based social networks showing the location selected by the user on the globe in FIG. 5 in more detail on a map, according to one illustrated embodiment.

FIG. 7 is a drawing of an example user interface screen of a software application of a system for facilitating location-based social networks showing the location selected by the user shown on the map in FIG. 6 in yet more detail along with interactive graphical markers representative of online social network identities of a plurality of members of an online social network, according to one illustrated embodiment.

FIG. 8A is a drawing of the example user interface screen of FIG. 7 additionally showing a member search portion, according to one illustrated embodiment.

FIG. 8B is a drawing of the example user interface screen of FIG. 8A showing search results, according to one illustrated embodiment.

FIG. 9A is a drawing of the example user interface screen of FIG. 8A additionally showing an interactive graphical marker representative of an online social network identity of a member being selected in order to initiate a video conference with the member, according to one illustrated embodiment.

FIG. 9B is a drawing of the example user interface screen of FIG. 9A showing an active video conference session with a selected member, according to one illustrated embodiment.

FIG. 9C is a drawing of an example interactive user interface element including an interactive graphical marker representative of an online social network identity of a member that may appear on the map shown in the user interface screens of FIGS. 7-9B, according to one illustrated embodiment.

FIG. 9D is a drawing of a version of the example user interface element of FIG. 9C transformed after having been selected by a user, according to one illustrated embodiment.

FIG. 10A is a drawing of the example user interface screen of FIG. 7 additionally showing a beacon set at a selected location on the map at which an event is to occur, according to one illustrated embodiment.

FIG. 10B is a drawing of the example user interface screen of FIG. 10A additionally showing routes on the map for members of the online social network to take to the location of the beacon from their current physical locations as indicated on the map, according to one illustrated embodiment.

FIG. 10C is a drawing of an example user interface menu element to facilitate the setting and management of beacons such as that shown in FIGS. 10A and 10B, according to one illustrated embodiment.

FIG. 10D is a drawing of an example user interface menu element including a setup panel to facilitate the user setting beacons such as that shown in FIGS. 10A and 10B, according to one illustrated embodiment.

FIG. 11A is a drawing of the example user interface screen of FIG. 7 additionally showing a voice input microphone user interface element, according to one illustrated embodiment.

FIG. 11B is a drawing of the example user interface screen of FIG. 1B additionally showing particular user profile pictures on the map highlighted to show results of a user query input using voice input, according to one illustrated embodiment.

FIG. 12 is a drawing of an example user interface screen having the map shown in FIG. 7 illustrating pairing of two social network members and a suggested meeting point on the map, according to one illustrated embodiment.

FIGS. 13A-13H are drawings of example user interface screens having the maps shown in FIGS. 5-7 illustrating progressive stages of an online game including a plurality of members of the online social network shown on the map as players, according to one illustrated embodiment.

FIGS. 14A-14D are drawings of example user interface screens having the maps shown in FIG. 7 illustrating a marker expandable by a user on the map to select various members of the online social network shown on the map to whom a message will be broadcast, according to one illustrated embodiment.

FIG. 14E is a drawing of an example user interface element including a marker expandable by a user such as that shown on the map in FIGS. 14C and 14D, according to one illustrated embodiment.

FIG. 15A is a drawing of an example user interface element illustrating selectable profile pictures of various members of an online social network, according to one illustrated embodiment.

FIG. 15B is a drawing of an example user interface element that may appear after selection of one of selectable profile pictures shown in FIG. 15A, according to one illustrated embodiment.

FIG. 16 is a flow diagram showing a method for providing information associated with members of an online social network in a system for facilitating location-based social networks, according to one illustrated embodiment.

FIG. 17 is a flow diagram showing a method for providing services associated with members of an online social network in a system for facilitating location-based social networks, according to another illustrated embodiment.

FIG. 18 is a flow diagram showing a method for presenting interactive graphical markers on locations on a map corresponding to current physical locations of devices of members of an online social network in a system for facilitating location-based social networks, according to another illustrated embodiment.

FIG. 19 is a flow diagram showing a method for providing a beacon to members of an online social network in a system for facilitating location-based social networks, according to another illustrated embodiment.

FIG. 20 is a flow diagram showing a method for indicating on a map the current location of selected members of an online social network in a system for facilitating location-based social networks, according to another illustrated embodiment.

FIG. 21 is a flow diagram showing a method for pairing two members of an online social network in a system for facilitating location-based social networks, according to another illustrated embodiment.

FIG. 22 is a flow diagram showing a method for moving on a map the indications of the current locations of members of an online social network as their locations change in a system for facilitating location-based social networks, according to another illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Various embodiments are described herein that provide systems, devices and methods for facilitating location-based social networks. For example, the system may use current Global Positioning System (GPS) data and/or functionality of various users' mobile devices to enable the users to share with their friends or contacts their current location in real time or near real time. There may be an individual graphical marker for each user that is presented on a map corresponding to the current location of the user's device. In particular, this interactive graphical marker is presented at a location on the map corresponding to the current physical location of the user's device based on the associated GPS data and/or other location data. If the location of the device moves, this is shown on the map by the associated graphical marker making corresponding movements on the map. In some embodiments, this graphical marker may be representative of an online social network identity of that user. For example, the individual interactive graphical marker may be a profile picture of the user or any other item or graphical element which identifies that user including, but not limited to: an image, photograph, avatar, icon, shape, symbol, name, nickname, username, user identifier, text, etc. In one example embodiment, each user may download and install an application or client on their device that displays this map which shows all the locations of their friends in real time.

In some embodiments, the graphical marker for each user is an interactive graphical marker that causes further functionality to occur if it is tapped, pressed, clicked on, or otherwise selected by a user. For example, when a user selects the interactive graphical marker of one of their friends, additional profile information about that friend may be presented or electronically communicated to the user. This may include, but is not limited to: name, age, address, gender, contact information, relationship status, personal information, demographic information, user profile data, user statistics, photographs, destination, previous locations visited, schedule, calendar information, friends or contacts lists, interests, type of car, etc. The user and/or friend may select to what extent, if any, additional information is to be presented. Another example of further functionality that may occur if the interactive graphical marker is tapped, pressed, clicked on or otherwise selected by a user is the initiation of a communication session with the user. The communication session may be a text chat session, a video chat session, a telephone or voice chat session, or may initiate sending of a text, email or other message. The selection of the interactive graphical marker may also in some embodiments cause another application or session to open associated with any one of a variety of different social networks or communication channels. Upon selection by a user of the interactive graphical marker, a menu may also appear that enables a user to select between a variety of such communication options, functionalities, and/or services enabling communication with the user represented by the interactive graphical marker.

A variety of other features and functionality making use of the interactive nature of the map and the interactive graphical markers displayed thereon representing the user's friends current locations may also be present. For example, the user may select a location on the map as a beacon and a communication will be automatically broadcast out to all or a select group of their friends' devices that includes the location information and/or directions to meet at the selected location. Also, the user may select one or more of the graphical markers displayed on the map representing a group of friends. This group of friends may then be that with which the user interacts, tracks, communicates with, or to whom one or more services are provided. For example, the user may select one or more of the graphical markers displayed on the map representing a group of friends with whom the user can instantly communicate, play a game, or otherwise interact. The various graphical markers displayed on the map and the various selected groups, subgroups and/or individuals represented by these graphical markers may be based on groups defined in various other online social media accounts and/or applications of the user, selected individually, and/or modified by the user, etc.

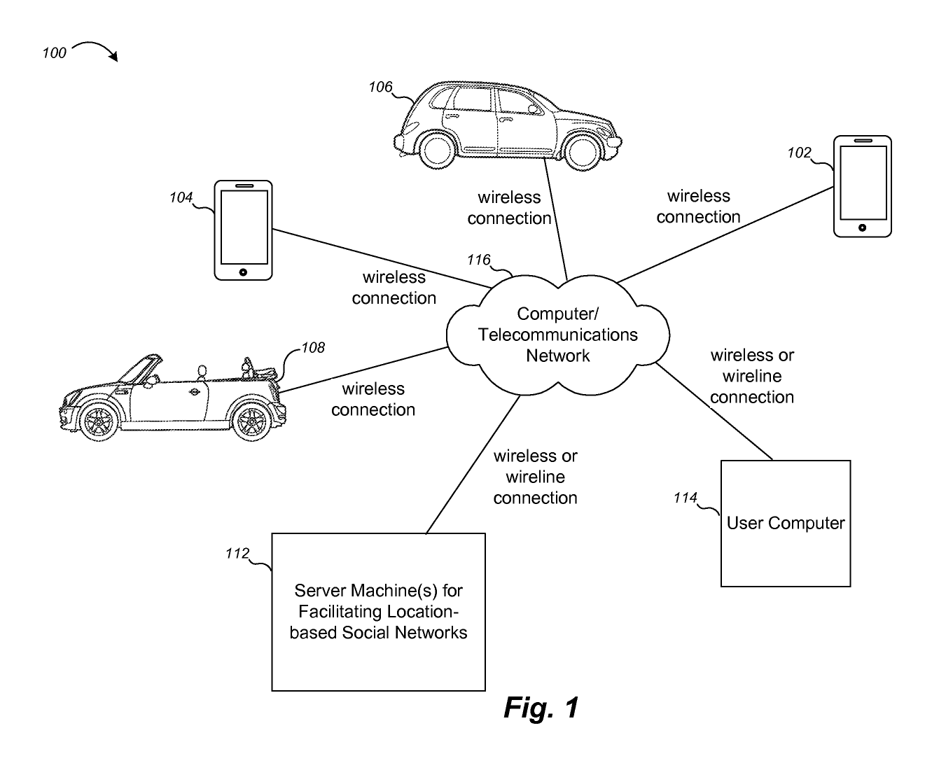

FIG. 1 is a system diagram of a networked environment 100, in which systems, devices and methods for facilitating location-based social networks may be a part, or in which they may be implemented, according to one illustrated embodiment.

The networked environment 100 may include a plurality of mobile devices (e.g., first mobile device 102 and second mobile device 104), a plurality of vehicles (e.g., vehicle 1 106 and vehicle 2 108), a server machine or machines for facilitating location-based social networks 112 and a user computer 114. The first mobile device 102 and second mobile device 104, vehicle 1 106 and vehicle 2 108, server machine for facilitating location-based social networks 112 and the user computer 114 are all communicatively coupled via a computer/telecommunications network 116. Additional mobile devices, landline telephones, servers, clients, switches, routers and service providers may also be present and included in the network environment, but are not illustrated for clarity of presentation.

The computer/telecommunications network 116 may be any telecommunications network, computer network or combination of telecommunications and computer networks that enables communication between the various devices connected to the network 116 shown in FIG. 1. For example, mobile telecommunications provided by network 116 may include various analog and/or digital mobile telecommunications, for example, including those according to the long-term evolution (LTE), or “4G LTE”, standard for wireless communication of high-speed data for mobile phones and data terminals based on the Global System for Mobile Communications (GSM)/Enhanced Data rates for GSM Evolution (EDGE) and Universal Mobile Telecommunications System (UMTS)/High Speed Packet Access (HSPA) network technologies, and/or other network technologies fulfilling specifications by the International Telecommunication Union.

The mobile devices 102 and 104, vehicle 106, vehicle 108, server machine for facilitating location-based social networks 112 and user computer 114 may be additionally or optionally linked by one or more other communication links or networks that comprise network 116. For example, a communications network of network 116 may include a local area network that uses wireless fidelity (Wi-Fi) high frequency radio signals to transmit and receive data over distances of a few hundred feet. The local area network may be a wireless local area network (WLAN) based on the Institute of Electric and Electronic Engineers (IEEE) 802.11 standards. However, other wired and wireless communications networks and protocols may be used to link the various devices and systems shown in FIG. 1. Thus, the mobile devices 102 and 104, vehicles 106 and 108, user computer 114 and server machine for facilitating location-based social networks 112 may have various applicable wireless transmitters and receivers and, in the case of using a Wi-Fi wireless link, may also have the corresponding executable Wi-Fi compatible network communications software that initiates, controls, maintains or manages the wireless link between the mobile devices 102 and 104, vehicles 106 and 108, user computer 114 and the server machine for facilitating location-based social networks 112, and the various other devices and systems within or connected to network 116 over the Wi-Fi, satellite and/or cellular signal of the network 116.

The network 116 may comprise connections to computing systems such as those in the mobile devices 102 and 104, vehicles 106 and 108, user computer 114 and server machine for facilitating location-based social networks 112 that provide services to the mobile devices 102 and 104, vehicles 106 and 108, user computer 114 and server machine for facilitating location-based social networks 112, and may itself represent multiple interconnected networks. For instance, wired and wireless enterprise-wide computer networks, intranets, extranets, and/or the Internet may be included in or comprise a part of network 116. Embodiments may include various types of communication networks including other telecommunications networks, cellular networks, paging networks, and other mobile networks. There may be any variety of computers, switching devices, routers, bridges, firewalls, edge devices, multiplexers, phone lines, cables, telecommunications equipment and other devices within network 116 and/or in the communications paths between the mobile devices 102 and 104, vehicles 106 and 108, user computer 114 and server machine for facilitating location-based social networks 112. Some or all of such equipment of network 116 may be owned, leased or controlled by various service providers.

In accordance with an aspect of the disclosure, mobile devices 102 and 104, vehicles 106 and 108, user computer 114 and server machine for facilitating location-based social networks 112 may contain discrete functional program modules that might make use of an application programming interface (API), or other object, software, firmware and/or hardware, to request services of one or more of the other entities within or connected to the network 116, such as mobile devices 102 and 104, vehicles 106 and 108, user computer 114 and server machine for facilitating location-based social networks 112. For example, communication can be provided over a communications medium, e.g., client and server systems running on any one of the first mobile device 102, second mobile device 104, vehicle 106, vehicle 108, server machine for facilitating location-based social networks 112 and user computer 114. These client and server systems may be coupled to one another via transmission control protocol/internet protocol (TCP/IP) connection(s) for high-capacity communication. The “client” is a member of a class or group that uses the services of another class or group to which it is not related. In computing, a client is a process, i.e., roughly a set of instructions or tasks, executed by hardware that requests a service provided by another program. Generally, the client process utilizes the requested service without having to “know” any working details about the other program or the service itself. In a client/server architecture, particularly a networked system, a client is usually a computer or device that accesses shared network resources provided by another computer or device, e.g., a server. In the example of FIG. 1 and the mobile devices 102 and 104 may be clients requesting the services of the server machine for facilitating location-based social networks 112 that is acting as a server. However, any entity in FIG. 1, including mobile devices 102 and 104, vehicles 106 and 108, user computer 114 and/or server machine for facilitating location-based social networks 112, can be considered a client, a server, or both, depending on the circumstances.

One or more cellular towers and stations may be part of a cellular network that is part of the computer/telecommunications network 116 and may be communicatively linked by one or more communications networks or communication mediums within the computer/telecommunications network 116 (e.g., using a cellular or other wired or wireless signal 116) in order to facilitate sending and receiving information in the form of synchronous or asynchronous voice communications, video, Global Positioning System (GPS) data, textual and/or encoded data to and from the mobile devices 102 and 104. This communication may be over a wireless signal on the cellular network of network 116 using applicable combinations and layers of telecommunications and networking protocols and standards such as 3G, HTTP and TCP/IP, satellite protocols, etc.

Although the physical environment of the network 116 may have connected devices such as computers and mobile cellular devices, the physical environment may alternatively or additionally have or be described as comprising various digital devices such as personal digital assistants (PDAs), televisions, MP3 players, etc., software objects such as interfaces, Component Object Model (COM) objects and the like.

There are a variety of systems, components, and network configurations that may also support distributed computing environments within the network 116. For example, computing systems may be connected together within the network 116 by wired or wireless systems, by local networks or by widely distributed networks. Currently, many networks are coupled to the Internet, which provides an infrastructure for widely distributed computing and encompasses many different networks. Any such infrastructures, whether coupled to the Internet or not, may be used in conjunction with, be connected to, or comprise part of the network 116.

The mobile devices 102 and 104 can take the form of any of a large variety of mobile communications and/or processing devices having a handheld form factor. Examples of such may include cellular phones, personal digital assistants or PDAs (e.g., Blackberry® devices, iPhone® devices, Android® devices, Windows devices), cellular enabled laptop computers, netbook computers and tablet devices (e.g., IPAD® devices).

Components of the computer/telecommunications network 116 that support, provide and/or facilitate communications devices on the computer/telecommunications network 116 may include those of a service provider. The service provider may be a cellular telephone service provider, landline telephone service provider, Internet service provider, Wi-Fi access service provider, cable service provider, GPS service provider, location service provider, satellite service provider, other data service provider, or a service provider providing any combination of such services, etc. Generally, the service provider charges subscribers for use of the services provided. In the example provided herein any one or more of mobile devices 102 and 104, vehicles 106 and 108, user computer 114 and server machine for facilitating location-based social networks 112 may use or include devices belonging to or used by those who subscribe directly or indirectly to services provided by a service provider. Also, the functions performed by the mobile devices 102 and 104, vehicles 106 and 108, user computer 114 and/or server machine for facilitating location-based social networks 112 may be performed by one or more systems connected to network 116 that individually perform and/or combine the functionalities of those systems described above.

The embodiments and applicable system components will be described in the general context of computer-executable instructions, such as program application modules, objects, or macros stored on computer- or processor-readable storage media and executed by a computer or processor. Those skilled in the relevant art will appreciate that the illustrated embodiments as well as other embodiments can be practiced with other system configurations and/or other computing system configurations, including hand-held devices, multiprocessor systems, microprocessor-based or programmable consumer electronics, personal computers (“PCs”), laptop computers, notebook computers, network PCs, mini computers, tablet devices, netbooks, mainframe computers, and the like. The embodiments can be practiced in distributed computing environments where tasks or modules are performed by remote processing devices, which are linked through a communications network such as network 116. In a distributed computing environment, program modules may be located in both local and/or remote memory storage devices.

In one embodiment, services and/or data are provided by the server machine(s) 112 over network 116 to one or more applications or software clients running on a plurality of mobile devices (e.g., first mobile device 102 and second mobile device 104), and/or a plurality of vehicles (e.g., vehicle 1 106 and vehicle 2 108). These services and/or data are provided by the server machine(s) 112 over network 116 and enable the users within the networked environment 100 to share with their friends or contacts their current location in real time or near real time. For example, the networked environment 100 may use current Global Positioning System (GPS) data and/or functionality of various users' mobile devices, such as first mobile device 102 and second mobile device 104, and/or the users' vehicles, such as vehicle 1 106 and vehicle 2 108, to enable the users to share with their friends or contacts their current location in real time or near real time over network 116. In particular, there may be an individual graphical marker for each user that is presented on a map displayed on user interface screens of first mobile device 102 and second mobile device 104 and/or on user interface screens in vehicle 1 106 and/or vehicle 2 108. For example, the application or client running on a user's mobile device 104 may include a map that shows thereon the location of mobile device 102, vehicle 106 and/or vehicle 108, which may be the devices or vehicles of various friends, contacts or other members of an online social network to which the user belongs. The information such as GPS data and/or related location services which communicate the current location of the first mobile device 102, second mobile device 104, vehicle 1 106 and vehicle 2 108 may be communicated over the network 116.

Communication of other further information and/or provision of services may also occur over network 116. This communication of other further information and/or provision of services may be initiated when the interactive graphical marker on the map displayed on mobile device 104, for example, is selected by the user of mobile device 104. Examples of such information and/or services include, but are not limited to: a one-on-one or group communication session; a one-on-one or group text chat session, a one-on-one or group video chat session, a one-on-one or group telephone conference or voice chat session, sending or broadcast of a text, email or other message; initiation or opening of another application or session associated with any one of a variety of different online social networks, members of such online social networks or communication channels; communication options, functionalities, and/or services enabling communication with the user(s) represented by the selected interactive graphical marker(s) on the map; distress calls, notifications and/or alerts; emergency calls, notifications and/or alerts; updates of information; location services; games, including location-based games, etc. The number and types of devices shown as part of the networked environment 100 in FIG. 1 is provided as an example and variation to the number and types of devices which may be included in the networked environment 100 is contemplated and exists in various embodiments.

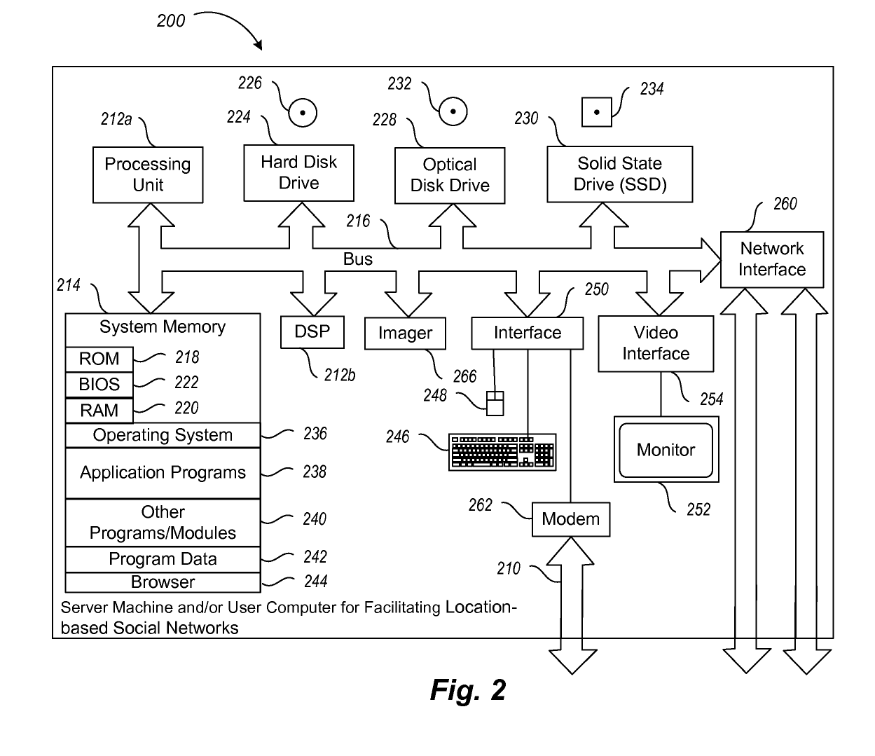

FIG. 2 is a schematic diagram of an example computer system of the server machine for facilitating location-based social networks and/or the user computer of FIG. 1, suitable for implementing systems, devices and methods for facilitating location-based social networks, according to one illustrated embodiment. The computer system 200 is suitable for implementing systems, devices and methods for facilitating location-based social networks as described herein, according to various illustrated embodiment. In some embodiments, some or all of the same, similar or equivalent structure and functionality of the computer system 200 shown in FIG. 2 and described herein may be that of, part of or operably connected to, the user computer 114 and/or a communication and/or computing system of vehicle 106 and/or vehicle 108 of FIG. 1. The computer system 200 will at times be referred to in the singular herein, but this is not intended to limit the embodiments to a single device since in typical embodiments, there may be more than one computer system or devices involved. Unless described otherwise, the construction and operation of the various blocks shown in FIG. 2 are of conventional design. As a result, such blocks need not be described in further detail herein, as they will be understood by those skilled in the relevant art.

The computer system 200 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSP) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the computer system 200, such as during start-up.

The computer system 200 may also include a plurality of interfaces such as network interface 260, interface 250 supporting modem 262 or any other wireless/wired interfaces.

The computer system 200 may include a hard disk drive 224 for reading from and writing to a hard disk 226, an optical disk drive 228 for reading from and writing to removable optical disks 232, and/or a solid state drive (SSD) 230 for reading from and writing to one or more non-removable or removable solid state memory devices 234 which include integrated circuit assemblies as memory to store data persistently. The optical disk 232 can be a DVD-RW, while the solid state memory device 234 may be a flash memory device, for example. The hard disk drive 224, optical disk drive 228 and SSD 230 may communicate with the processing unit 212 via the system bus 216. The hard disk drive 224, optical disk drive 228 and SSD 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program modules and other data for the computer system 200. Although the depicted computer system 200 is illustrated employing a hard disk 224, optical disk 228 and SSD 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, digital versatile disks (DVD) or other optical disk storage, magnetic cassettes, magnetic tape or other magnetic storage devices, SSD, solid state memory or any other medium which can be used to store the desired information and which may be accessed by processing unit 212a.

Program modules can be stored in the system memory 214, such as an operating system 236, one or more application programs 238, other programs or modules 240 and program data 242. Application programs 238 may include instructions that cause the processor(s) 212 to facilitate location-based social networks between various devices as described herein such as, for example, mobile devices 102 and 104, vehicle 106, vehicle 108, the one or more server machines for facilitating location-based social networks 112 and user computer 114 of FIG. 1. In particular the program modules 240 may include modules that correspond to and/or, work in conjunction with the various hardware components of the computer system 200, implement the functions of one or more location services, online social network servers, video chat services, user management systems, location management systems, map display systems and/or video chat systems, user registration components, authentication components, communications components, association components, storage components, database searching components, etc., of the server machine for facilitating location-based social networks, the user computer 114 and/or other device(s) of the system for facilitating location-based social networks shown in FIG. 1. For example, various program modules 240 may include instructions for handling security such as password or other access protection and communications encryption and also providing online social network servers, location services, video chat services and other one-on-one or group communication services. The system memory 214 may also include communications programs, for example, a Web client, mobile device application or browser 244 for permitting the computer system 200 to access and exchange data with sources such as Web sites of the Internet, corporate intranets, extranets, GPS services and/or devices, or other networks and devices as described herein, as well as other server applications on server computing systems. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Google, Apple, and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the solid state memory device(s) 234 of the SSD 230.

An operator can enter commands and information into the computer system 200 through input devices such as a touch screen or keyboard 246 and/or a pointing device such as a mouse 248, and/or via a graphical user interface. Other input devices can include a microphone, joystick, game pad, tablet, scanner, digital camera, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The computer system 200 can include other output devices, such as speakers, printers, etc.

The computer system 200 can operate in a networked environment using logical connections to one or more remote computers and/or devices as described above with reference to FIG. 1. For example, the computer system 200 can operate in a networked environment using logical connections to one or more mobile devices, vehicles, landline telephones, end user computers and other service providers or information servers. Communications may be via a wired and/or wireless network architecture, for instance, wired and wireless enterprise-wide computer networks, intranets, extranets, telecommunications networks, cellular networks, paging networks, and other mobile networks.

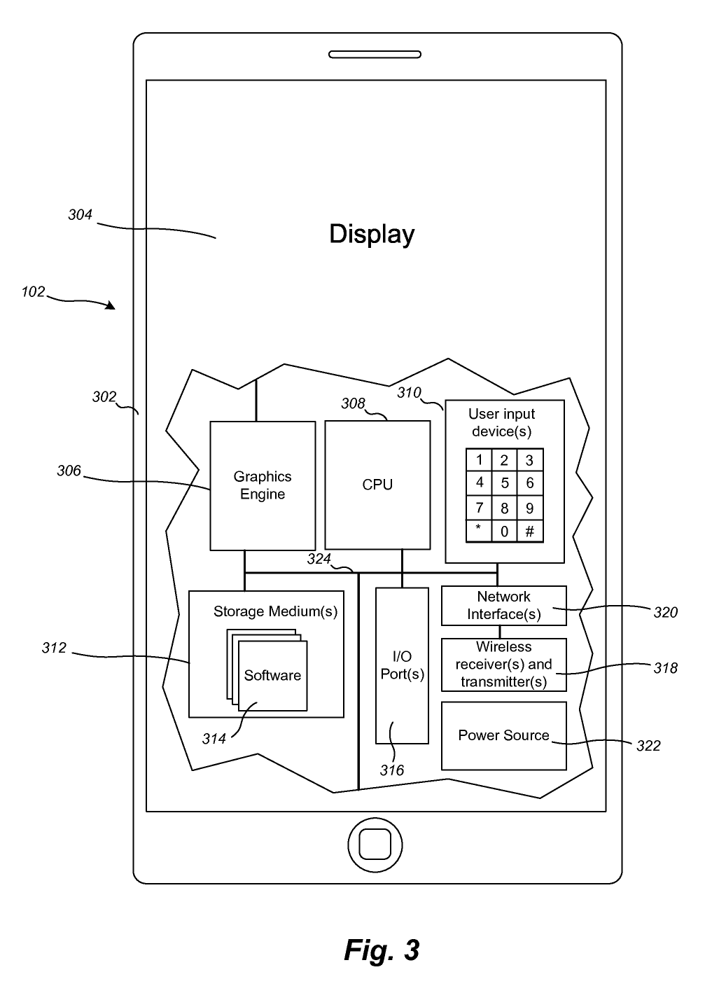

FIG. 3 is a schematic view of one of the first mobile device 102 of FIG. 1, shown in more detail according to one illustrated embodiment, the mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), and a power source. The first mobile device 102 may have a housing 302, a display 304, a graphics engine 306, a central processing unit (CPU) 238, one or more user input devices 310, one or more storage mediums 312 having various software modules 314 stored thereon comprising instructions that are executable by the CPU 308, input/output (I/O) port(s) 316, one or more wireless receivers and transmitters 318, one or more network interfaces 320, and a power source 322. In some embodiments, some or all of the same, similar or equivalent structure and functionality of the first mobile device 102 shown in FIG. 3 and described herein may be that of, part of or operably connected to a communication and/or computing system of vehicle 106 and/or vehicle 108.

As previously noted, the first mobile device 102 may be any of a large variety of communications devices such as a cellular telephone, a smartphone, a portable media player (PMP), a personal digital assistant (PDA), a mobile communications device, a portable computer with built-in or add-on cellular communications, a portable game console, a global positioning system (GPS), a handheld industrial electronic device, or the like, or any combination thereof. The first mobile device 102 has at least one central processing unit (CPU) 308 which may be a scalar processor, a digital signal processor (DSP), a reduced instruction set (RISC) processor, or any other suitable processor. The central processing unit (CPU) 308, display 304, graphics engine 306, one or more user input devices 310, one or more storage mediums 312, input/output (I/O) port(s) 316, one or more wireless receivers and transmitters 318, and one or more network interfaces 320 may all be communicatively connected to each other via a system bus 324. The system bus 324 can employ any suitable bus structures or architectures, including a memory bus with memory controller, a peripheral bus, and/or a local bus.

The first mobile device 102 also includes one or more volatile and/or non-volatile storage medium(s) 312. The storage mediums 312 may be comprised of any single or suitable combination of various types of processor-readable storage media and may store instructions and data acted on by CPU 308. For example, a particular collection of software instructions comprising software 314 and/or firmware instructions comprising firmware are executed by CPU 308. The software or firmware instructions generally control many of the operations of the first mobile device 102 and a subset of the software and/or firmware instructions may perform functions to operatively configure hardware and other software in the first mobile device 102 to provide the initiation, control and maintenance of applicable computer network and telecommunication links from the first mobile device 102 to the server machine for facilitating location-based social networks 112, another subscriber device such as second mobile device 104, vehicle 106, vehicle 108 and/or a user computer 114 via the network 116 as shown in FIG. 1 using the wireless receiver(s) and transmitter(s) 318, network interface(s) 320, and/or I/O ports 316. An example of one such applicable computer network and telecommunication link is that between the mobile device 102 and a global positioning system (GPS) or other location service that enables data indicative of the location of the mobile device 102 to be communicated between the mobile device 102 and a GPS, other location service and/or other devices such as those shown in FIG. 1. The mobile device may include any single or suitable combination of various types of GPS hardware (e.g., as part of the wireless receiver(s) and transmitter(s) 318) and software and/or firmware components (e.g., as part of the software 314) that enable the current physical location of the mobile device 102 to be tracked and communicated accordingly as the mobile device moves to facilitate the methods, operations and services described herein.

By way of example, and not limitation, the storage medium(s) 312 may be processor-readable storage media which may comprise any combination of computer storage media including volatile and nonvolatile, removable and non-removable media implemented in any method or technology for storage of information such as computer readable instructions, data structures, program modules or other data. Combinations of any of the above should also be included within the scope of processor-readable storage media.

The storage medium(s) 312 may include system memory which includes computer storage media in the form of volatile and/or nonvolatile memory such as read-only memory (ROM) and random access memory (RAM). A basic input/output system (BIOS), containing the basic routines that help to transfer information between elements within first mobile device 102, such as during start-up or power-on, is typically stored in ROM. RAM typically contains data and/or program modules that are immediately accessible to and/or presently being operated on by CPU 308. By way of example, and not limitation, FIG. 3 illustrates software modules 314 including an operating system, application programs and other program modules that implement applicable processes and methods described herein for facilitating location-based social networks.

The first mobile device 102 may also include other removable/non-removable, volatile/nonvolatile computer storage media drives. By way of example only, the storage medium(s) 312 may include a hard disk drive or solid state storage drive that reads from or writes to non-removable, nonvolatile media, a SSD that reads from or writes to a removable, nonvolatile SSD, and/or an optical disk drive that reads from or writes to a removable, nonvolatile optical disk such as a DVD-RW or other optical media. Other removable/non-removable, volatile/nonvolatile computer storage media that can be used in an operating environment of the first mobile device 102 include, but are not limited to, flash memory cards, other types of digital versatile disks (DVDs), micro-discs, digital video tape, solid state RAM, solid state ROM, and the like. The storage medium(s) are typically connected to the system bus 324 through a non-removable memory interface. The storage medium(s) 312 discussed above and illustrated in FIG. 3, provide storage of computer readable instructions, data structures, program modules and other data for the first mobile device 102. In FIG. 3, for example, a storage medium may store software 314 including an operating system, application programs, other program modules, and program data. The storage medium(s) 312 may implement a file system, a flat memory architecture, a database, or any other method or combination capable for storing such information.

A user may enter commands and information into the first mobile device 102 through touch screen display 304 or the one or more other input device(s) 310 such as a keypad, keyboard, camera, motion sensor, position sensor, light sensor, biometric data sensor, accelerometer, or a pointing device, commonly referred to as a mouse, trackball or touch pad. Other input devices of the first mobile device 102 may include a microphone, joystick, thumbstick, game pad, optical scanner, other sensors, or the like. These and other input devices are often connected to the CPU 308 through a user input interface that is coupled to the system bus 324, but may be connected by other interface and bus structures, such as a parallel port, serial port, wireless port, game port or a universal serial bus (USB). Generally, a unique software driver stored in software 314 configures each input mechanism to sense user input, and then the software driver provides data points that are acted on by CPU 308 under the direction of other software 314. The display is also connected to the system bus 324 via an interface, such as the graphics engine 306. In addition to the display 304, the first mobile device 102 may also include other peripheral output devices such as speakers, a printer, a projector, an external monitor, etc., which may be connected through one or more analog or digital I/O ports 316, network interface(s) 320 or wireless receiver(s) and transmitter(s) 318.

The first mobile device 102 may operate in a networked environment using connections to one or more remote computers or devices, such as a remote computer or device of the server machine for facilitating location-based social networks 112, second mobile device 104, vehicle 106, vehicle 108, and/or user computer 114 within or connected to the computer network 116 of FIG. 1 and described above. The remote computer within or connected to network 116 may be a personal computer, another mobile device, a server, a router, a network PC, a peer device or other common network node, and typically includes many or all of the elements described above relative to the computer system 200 of FIG. 2. Such connections to the network 116 may include connections over cellular, satellite, local area network (LAN) connections or wide area network (WAN) connections as described above, and/or other networks.

When used in a LAN or WAN networking environment, the first mobile device 102 may be connected via the wireless receiver(s) and transmitter(s) 318 and network interface(s) 320, which may include, for example, cellular receiver(s) and transmitter(s), Wi-Fi receiver(s) and transmitter(s), and associated network interface(s). When used in a WAN networking environment, the first mobile device 102 may include a modem or other means as part of the network interface(s) for establishing communications over the WAN, such as the Internet. The wireless receiver(s) and transmitter(s) 318 and the network interface(s) 320 may be communicatively connected to the system bus 324. In a networked environment, program modules depicted relative to the first mobile device 102, or portions thereof, may be stored in a remote memory storage device of a remote system.

The first mobile device 102 has a collection of I/O ports 316 and/or short range wireless receiver(s) and transmitter(s) 318 and network interface(s) 320 for passing data over short distances to and from the first mobile device 102 or for coupling additional storage to the first mobile device 102. For example, serial ports, USB ports, Wi-Fi ports, Bluetooth® ports, IEEE 1394 (i.e., FireWire), and the like can communicatively couple the first mobile device 102 to other computing apparatuses. Compact Flash (CF) ports, Secure Digital (SD) ports, and the like can couple a memory device to the first mobile device 102 for reading and writing by the CPU 308 or couple the first mobile device 102 to other communications interfaces such as Wi-Fi or Bluetooth transmitters/receivers and/or network interfaces.

First mobile device 102 also has a power source 322 (e.g., a battery). The power source 322 may supply energy for all the components of the first mobile device 102 that require power when a traditional, wired or wireless power source is unavailable or otherwise not connected. Other various suitable system architectures and designs of the first mobile device 102 are contemplated and may be utilized which provide the same, similar or equivalent functionality as those described herein.

It should be understood that the various techniques, components and modules described herein for facilitating location-based social networks may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as various solid state memory devices, DVD-RW, RAM, hard drives, flash drives, or any other machine-readable or processor-readable storage medium wherein, when the program code is loaded into and executed by a machine, such as a processor of a computer, vehicle or mobile device, the machine becomes an apparatus for practicing various embodiments. In the case of program code execution on programmable computers, vehicles or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system including the example computer system 200 depicted in FIG. 2 and also in FIG. 3 of first mobile device 102. However, the program(s) can be implemented in assembly or machine language, if desired. In any case, the language may be a compiled or interpreted language, and combined with hardware implementations.

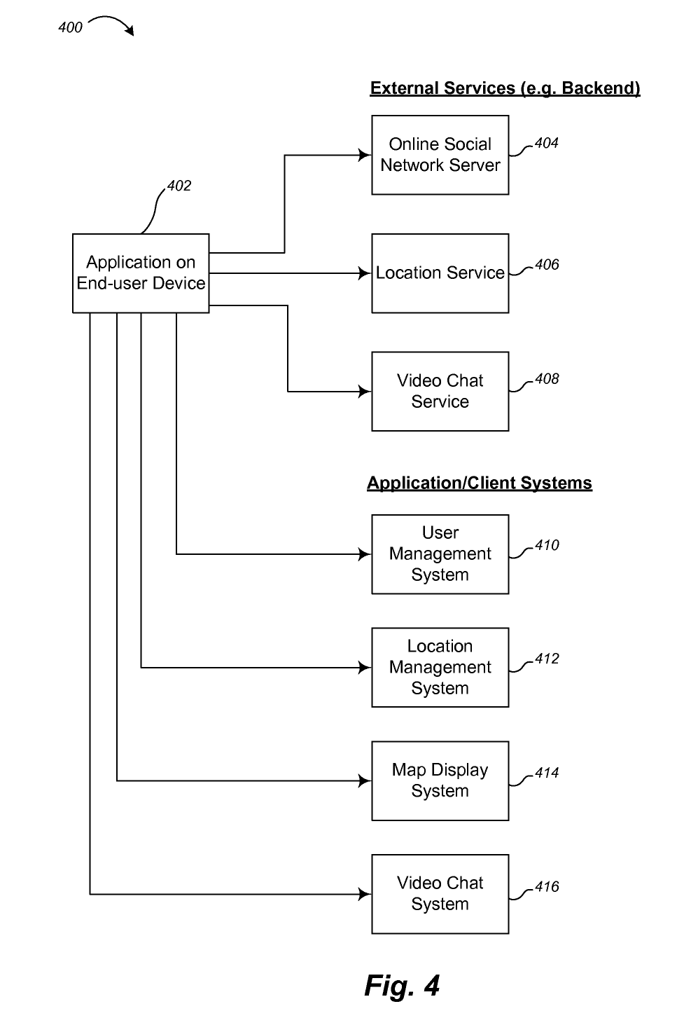

FIG. 4 is a block diagram representing example system architecture 400 of a system for facilitating location-based social networks, according to one illustrated embodiment.

In particular, shown is a block representing a software application 402 running on an end-user device, such as mobile device 102, mobile device 104, vehicle 106, vehicle 108, and/or user computer 114 of FIG. 1. Also shown is a group of blocks representing systems providing external services (e.g., backend services). Such external services may be available, for example, via a software application programming interface (API) available to the application on the end user device 402. These include online social network server 404, location service 406 and video chat service 408. The online social network server 404, location service 406 and video chat service 408 may represent any combination of the physical server machines providing these services and/or software components running on such machines. Such server machines are located remotely from the end-user device. For example, the online social network server 404, location service 406 and/or video chat service 408 may be provided by the server machine(s) for facilitating location-based social networks 112 shown in FIG. 1 and may be connected over network 116 to the end-user device, such as mobile device 102. However, in other alternative embodiments some or all of such services or related services may be provided by any suitable combination of hardware and software components running on the end-user device itself.

The application on the end-user device may, for example, be a software client (also referred to as an “app”) running on the mobile device 102 shown in FIG. 1 and FIG. 2. This software client may provide a graphical user interface on which is presented a map that indicates the current locations of the user's connections as defined in the user's online social network account or accounts, or selected groups of other users. These various selected groups, subgroups and/or individuals may be based on groups defined in various other online social network accounts and/or applications of the user, selected individually, and/or modified by the user, etc. An online social network as used herein means any database of user accounts that is accessible remotely over a computer network in which each user can create and save associations in their account with other users. These associations define a particular relationship between one or more users and are referred to herein as “connections”, but this term generally includes “friends”, “connections”, “contacts”, “associates”, “members”, “followers” of the user and those the user is “following”, etc., as defined in one or more online social network accounts of the user.

Communication between the application on the end-user device 402 and the online social network server 404 may provide such data regarding the user's online social network(s), connections, and the applicable user accounts. The online social network server 404 may also provide the authentication of the applicable credentials provided by the application on the end-user device 402 or otherwise received from the mobile device 102 and performs other applicable security protocols in order to provide the related data from the online social network account of the user and/or other users to the application on the end-user device 402 to enable the application on the end-user device 402 to perform the operations and provide the functionality and features described herein.

The locations of the user's associates which are indicated on the map by graphical markers may be based on or obtained via the GPS coordinates or other data available from the devices of the other users, such as those of the user's connections on an online social network. This GPS data or other applicable location data that enables the current location of other devices to be known may be provided by the location service 406 to the application on the end-user device 402. Also, the GPS data or other applicable location data that enables the current location of the user's mobile device 102 to be known to others may also be provided to the location service 406 by the application on the end-user device 402.

The video chat service 408 may provide video and data services usable by the camera, microphone, speakers and/or display of the mobile device 102. These video and data services enable the mobile device 102, via the video chat system 416, to provide a video chat session between the user and one or more other users selected by the user from the map displayed on the mobile device 102.

Also shown is a group of application/client systems. Such systems include a user management system 410, a location management system 412, a map display system 414 and a video chat system 416. Generally these application/client systems comprise any combination of the applicable hardware and software components running on the end-user device, such as mobile device 102 shown in FIG. 1 and in more detail in FIG. 3, that provides the corresponding functionality as described herein. However, in other alternative embodiments some or all of functionality provided by such systems or related services may be provided by any suitable combination of hardware and software components located on machines remote from the end-user device, such as on the server machine(s) for facilitating location-based social networks 112 shown in FIG. 1.

The user management system 410 provides management and tracking of data regarding the user and the user's connections such that data regarding the user and the user's connections may be provided to the user on the end-user device (e.g., mobile device 102) and to enable related functionality for facilitating location-based social networks described herein. An example of such data is the user identification and location data of the user and the user's connections. Examples of other such data may include, but is not limited to data regarding one or more of: name, age, address, gender, contact information, relationship status, personal information, demographic information, user profile data, user statistics, photographs, destination, previous locations visited, schedule, calendar information, friends or contacts lists, interests, type of car, etc. The location management system 412 then uses such current location data to provide indications to the map display system 414 of locations of some or a selected group of users. The location management system 412 also uses such data to enable related functionality for facilitating location-based social networks described herein regarding locations selected or presented on the displayed map.

The map display system 414 then presents the map and the graphical markers representative of the user's connections on the map at locations on the map corresponding to the current physical locations of the user's connections (or selected group of connections). The video chat system 416 may also receive input regarding selections by the user of other users represented on the map with which the user wants to initiate a video chat session. The video chat system 416 interacts with the video chat service 408, such as via an API, to receive and manage the applicable video and data services usable by the camera, microphone, speakers and/or display of the mobile device 102. These video and data services enable the video chat system 416 to provide a video chat session between the user and one or more other users selected by the user from the map displayed on the mobile device 102. The video chat session may be a one-on-one video chat session or a group video chat session between the selected users.

The example system architecture 400 shown in FIG. 4 illustrates one possible architecture that a system for facilitating location-based social networks as described herein may use. However, variations to the system architecture 400 are contemplated and exist in various different embodiments that may provide some or all of the same or similar functionality and features described herein. For example, there may be fewer, more or different specific external services and/or application/client systems than those shown in the example provided in FIG. 4. Some of the additional example external services and/or application/client systems may include, but are not limited to, those related to services enabling one or more of: text chat sessions; telephone or voice chat sessions; initiation of sending of a text, email or other message; opening of another application or session associated with any one of a variety of different social networks or communication channels; posting of an image or photograph; direction services; communication options, functionalities, and/or services enabling communication with the user(s) represented by selected interactive graphical marker(s) on the map; distress calls, notifications and/or alerts; emergency calls, notifications and/or alerts; updates of information; location services; tracking services; playing of games, including location-based games; selection between a variety of such communication options, functionalities, and/or services enabling communication with the user represented by a selected graphical marker displayed on the map, etc.

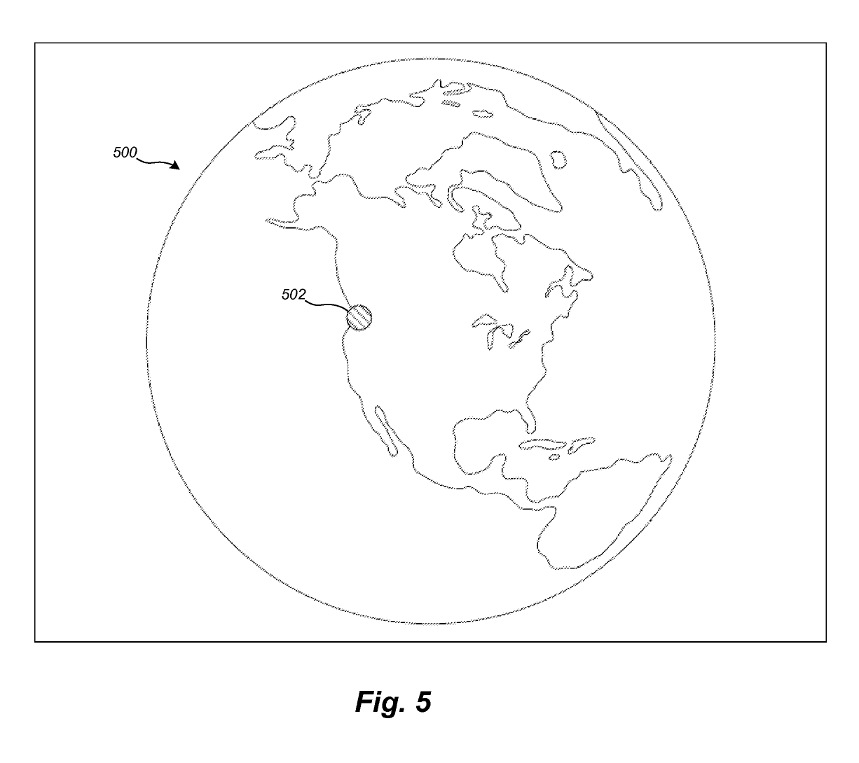

FIG. 5 is a drawing of an example user interface screen of a software application of a system for facilitating location-based social networks showing a location on a globe selected by a user, according to one illustrated embodiment. The software application may be one that is running on an end-user device, such as mobile device 102 shown in FIGS. 1 and 2. The application on the end-user device may be one such as that represented by block 402 in FIG. 4, shown within the example system architecture 400.

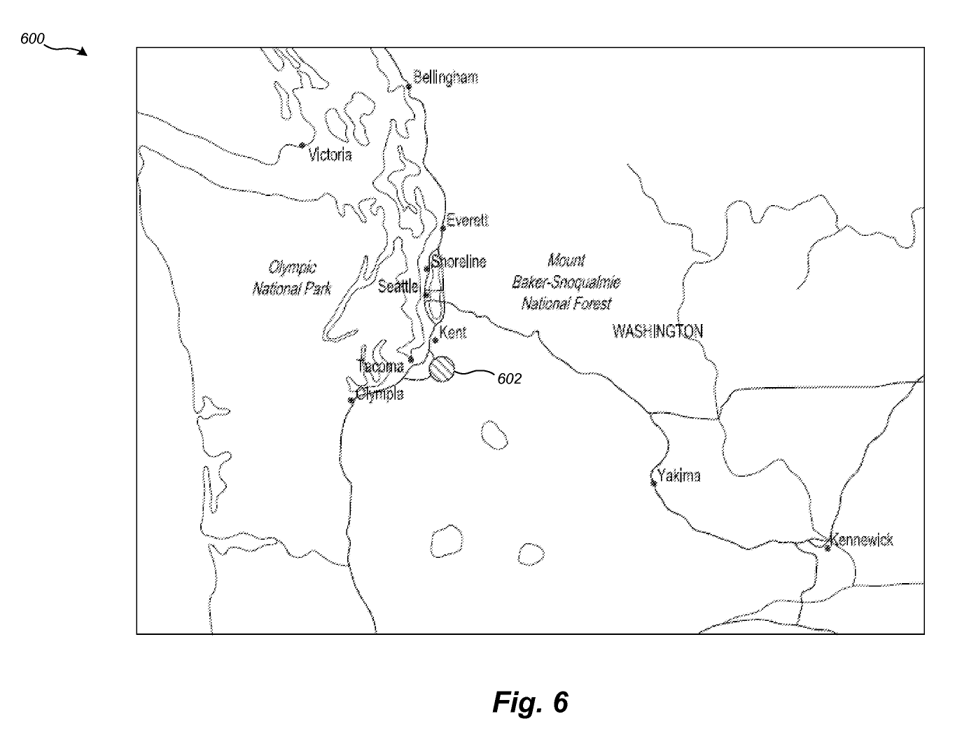

In the present example embodiment, the user is presented with a graphical user interface displaying an interactive map of the earth, such as a globe 500 as shown in FIG. 5. The user can then zoom in on a particular location on the globe 500 by placing a pin 502 on the globe 500 at the selected location, or otherwise indicating the selected location on the globe 500. For example, FIG. 6 is a drawing of the example user interface screen showing the location selected by the user on the globe in FIG. 5 in more detail on a map 600 after the user has selected the location for the application to zoom in on. The user can then zoom further in on a particular location on the map 600 by placing another pin 602 on the map 600 at the selected location, or otherwise indicating the selected location on the map 600.

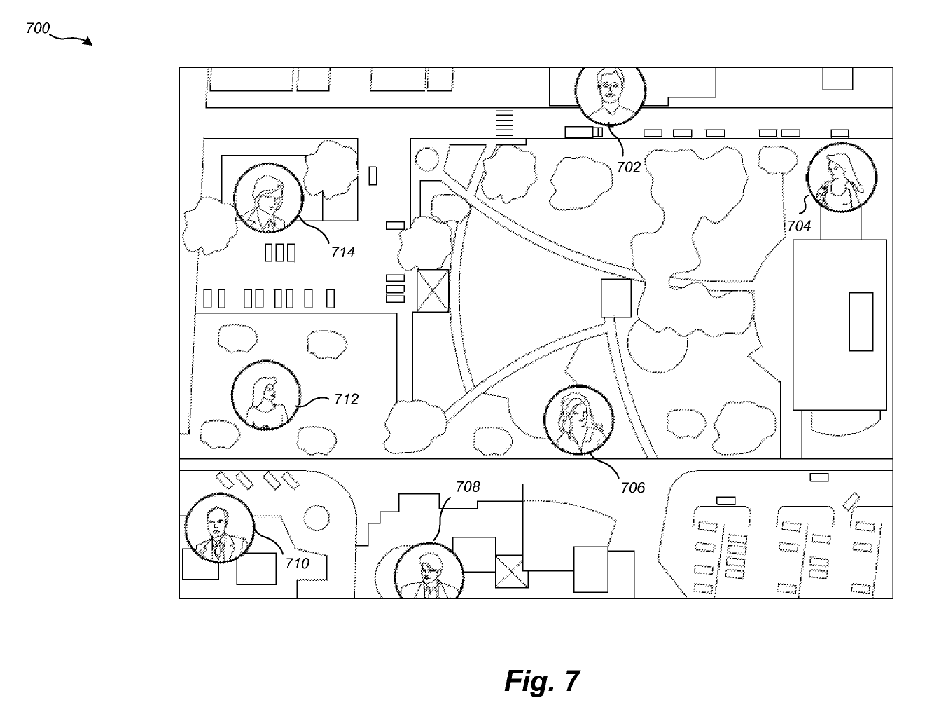

FIG. 7 is a drawing of an example user interface screen of a software application of the system for facilitating location-based social networks described herein showing the location selected by the user shown on the map 600 in FIG. 6 in yet more detail on a displayed map 700 along with graphical markers 702, 704, 706, 708, 710, 712 and 714, representative of online social network identities of a plurality of members of an online social network, according to one illustrated embodiment. For example, the system may use current Global Positioning System (GPS) data and/or functionality of various users' mobile devices to enable the users to share with their friends or contacts their current location in real time or near real time. There may be an individual graphical marker for each user that is presented on the map 700 corresponding to the current location of the user's device. For example interactive graphical marker 712 is presented at a location on the map 700 corresponding to the current physical location of the user's device represented by marker 712 based on the associated GPS data and/or other location data. If the location of the device of the user represented by the graphical marker 712 moves, this is shown on the map 700 by the associated graphical marker 712 making corresponding movements on the map. This graphical marker 712 may be representative of an online social network identity of that user in a variety of manners. For example, the individual interactive graphical marker may be a profile picture of the user, such as that shown in FIG. 7, or any other item or graphical element which identifies that user including, but not limited to: an image, photograph, avatar, icon, shape, symbol, name, nickname, username, user identifier, text, etc. In one example embodiment, each user may download and install an application or client on their device that displays a map such as map 700 which shows all the locations of their connections in real time.

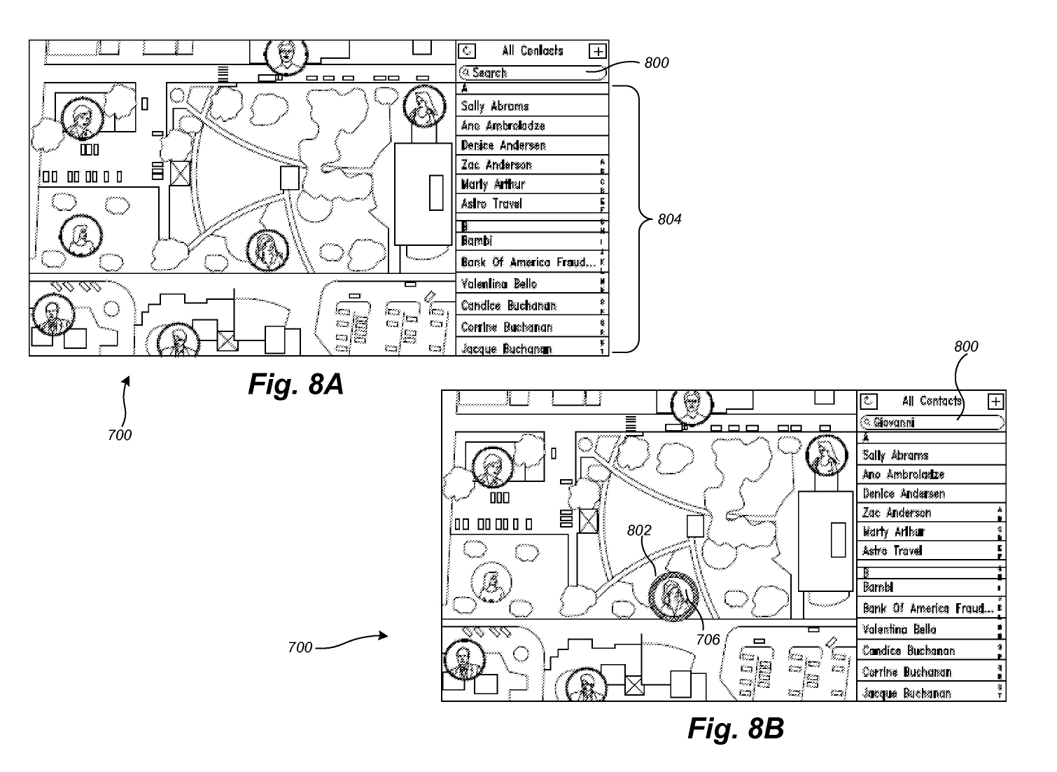

FIG. 8A is a drawing of the example user interface screen of FIG. 7 additionally showing a search term entry field 800 and a user directory 804. FIG. 8B is a drawing of the example user interface screen of FIG. 8A showing the search results, according to one illustrated embodiment. In particular, a user may input search information, terms, keywords or other search criteria to find particular users matching such search criteria. In the example shown in FIG. 8, the user entered a user's name “Giovanni” in the search term entry field 800. The graphical marker 706 corresponding to the user matching the search criteria is then highlighted 802 on the map as shown in FIG. 8B or otherwise indicated as being a possible match.

In some embodiments, the graphical markers 702, 704, 706, 708, 710, 712 and 714 are interactive graphical markers that cause further functionality to occur if they are tapped, pressed, clicked on, or otherwise selected by a user. For example, when a user selects the interactive graphical marker of one of their friends, additional profile information about that friend may be presented or electronically communicated to the user. This may include, but is not limited to: name, age, address, gender, contact information, relationship status, personal information, demographic information, user profile data, user statistics, photographs, destination, previous locations visited, schedule, calendar information, friends or contacts lists, interests, type of car, etc. The user and/or friend may select to what extent, if any, such additional information is to be presented.

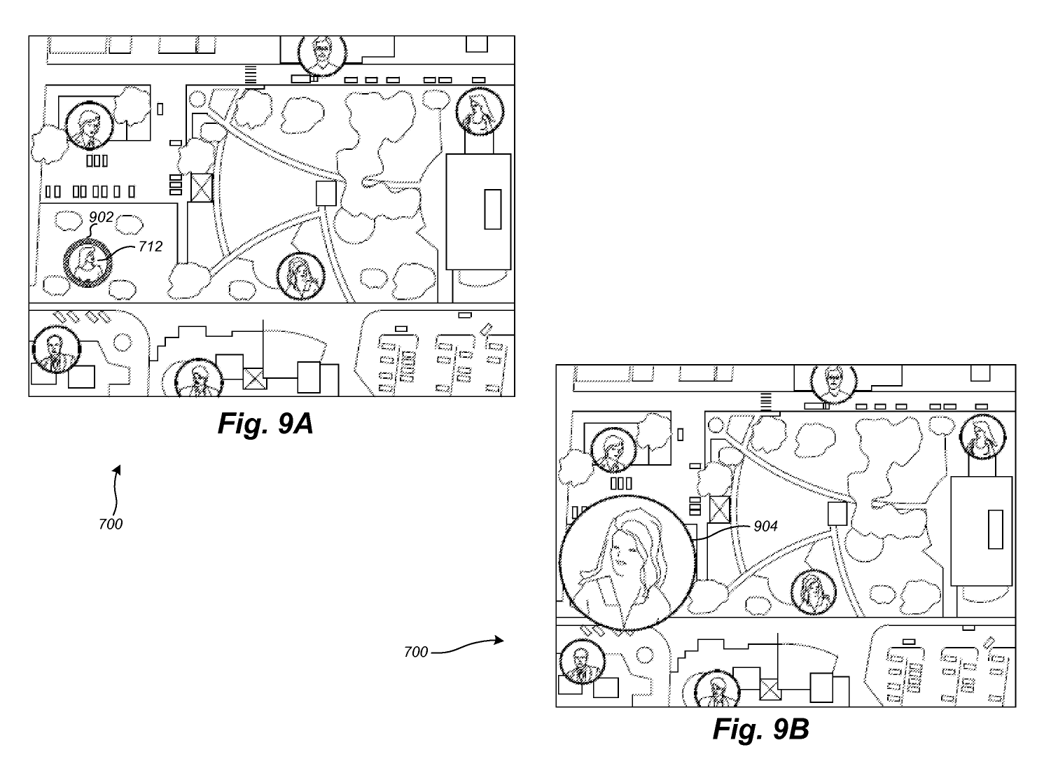

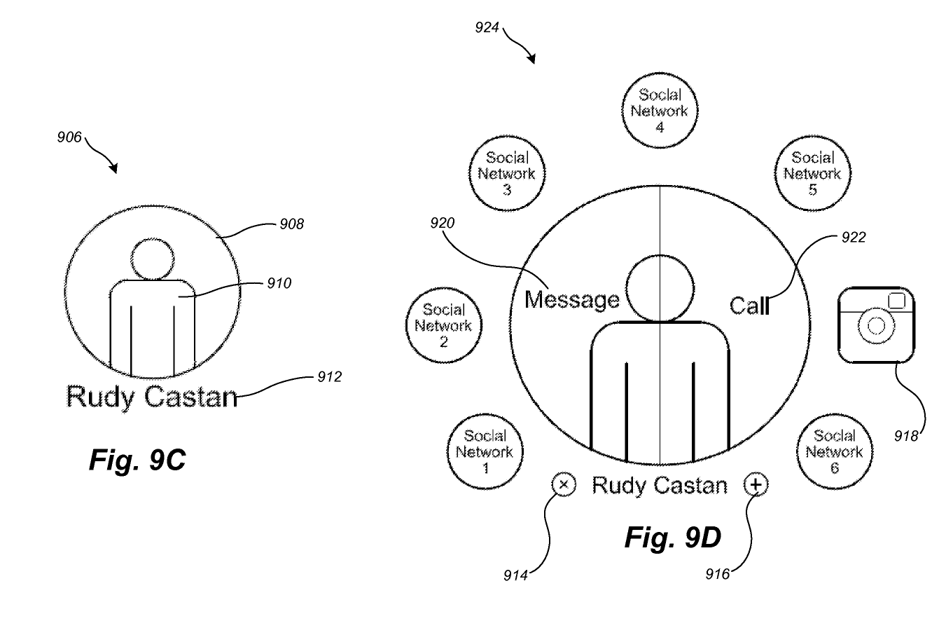

Another example of further functionality that may occur if the interactive graphical marker representing the online social network identity of the user is tapped, pressed, clicked on or otherwise selected by a user is the initiation of a communication session with the user represented by the selected graphical marker. For example, FIG. 9A is a drawing of the example user interface screen of FIG. 8A additionally showing the interactive graphical marker 712 representative of an online social network identity of a member being selected in order to initiate a video conference with the corresponding member, according to one illustrated embodiment. Once selected, the graphical marker 712 is highlighted as shown by the highlighted ring 902 surrounding the profile photo of the member that comprises the marker. However, other types of highlighting, bolding, or any other type of indication that the marker 712 has been selected may be used in various alternative embodiments.

In response to the selection, the marker 712 may be transformed or otherwise replaced by an online video chat session window 904, as shown in FIG. 9B, in which a video conference with the corresponding member is initiated using the member's contact information. For example, the video chat session window 904 may be larger than the graphical marker 712 to accommodate better viewing of the video session with the member. If the user selects multiple graphical markers on the map 700, a group video conference session may be initiated between the user and all the members represented by the selected graphical markers. This would allow an individual to have multiple, miniaturized video, or voice chats/conference calls on the map 700 simultaneously or at least partially concurrently. Users can mass-monitor an event by viewing it through several other user's cameras. A user can switch between a map-mode conference call and the regular-mode conference call which simply shows video-feeds in a matrix format. These smaller live video feeds can be resized easily by the user pinching or expanding each in order to see more of the map 700 beneath.

FIG. 9C is a drawing of an interactive user interface element 906 including an interactive graphical marker 908 representative of an online social network identity of a member that may appear on the map 700 shown in the user interface screens of FIGS. 7-9B. In the present example, included as part of the graphical marker 908 is a profile photo 910 of the user whose identity is represented by the graphical marker 906. In some embodiments, the user's name (e.g., “Rudy Castan”) or other identifier may also be included as part of the graphical marker 908.

FIG. 9D is a drawing of a version of the example user interface element 906 of FIG. 9C transformed after having been selected by a user, according to one illustrated embodiment. The selection of the interactive graphical marker 906 may also in some embodiments cause another application or session to open associated with any one of a variety of different social networks or communication channels. Also, as shown in FIGS. 9C and 9D, upon selection by a user of the interactive graphical marker 906, a menu may also appear that enables a user to select between a variety of such communication options, platforms, functionalities, and/or services enabling communication with the user represented by the interactive graphical marker. For example, shown in FIG. 9D is a graphical user interface menu 924 including a number of options from which the user may select to communicate with the selected member represented by the interactive graphical marker 906. These include, for example, a video chat option 918 and other communication options available on or through various different social network platforms (social network 1, social network 2, social network 3, social network 4, social network 5, and social network 6). Individual social network platforms may include, but are not limited to: Facebook®, Twitter®, Linkedin®, Instagram®, Google+®, Pinterest®, Foursquare®, etc. For example, selection of the corresponding social network platform (social network 1, social network 2, social network 3, social network 4, social network 5, and social network 6) may cause another application, session or channel associated with the selected social network to be opened, accessed or otherwise activated.

Shown also are selectable user interface elements providing options for the user to either message 920 or call 922 the selected member via the online social network associated with the system for facilitating location-based social networks described herein and/or other messages and voice call platforms. A block button 914 is shown which enables the user to block the selected member such that the selected member will not be able to see a graphical marker representing the user on the member's own corresponding map or otherwise see the user's information. An add button 916 is shown which enables the user to add the selected member to the user's friends list within an online social network associated with the system for facilitating location-based social networks or otherwise create an association with that selected user as a connection on one or more other online social networks of the user.

A scenario according to one example embodiment, is that after the selected member's (“Rudy's”) profile photo 910 is touched by the user on the user's mobile device, the profile reveals other social networks (social network 1, social network 2, social network 3, social network 4, social network 5, and social network 6) to which Rudy is connected and to which Rudy has chosen to link the online social network associated with the system for facilitating location-based social networks described herein. The user can tap on any of social network 1, social network 2, social network 3, social network 4, social network 5, or social network 6 and be redirected to the selected social network profile of Rudy. Tapping on these buttons (social network 1, social network 2, social network 3, social network 4, social network 5 or social network 6) may also allow these other social networks various functionality in the online social network associated with the system for facilitating location-based social networks described herein.

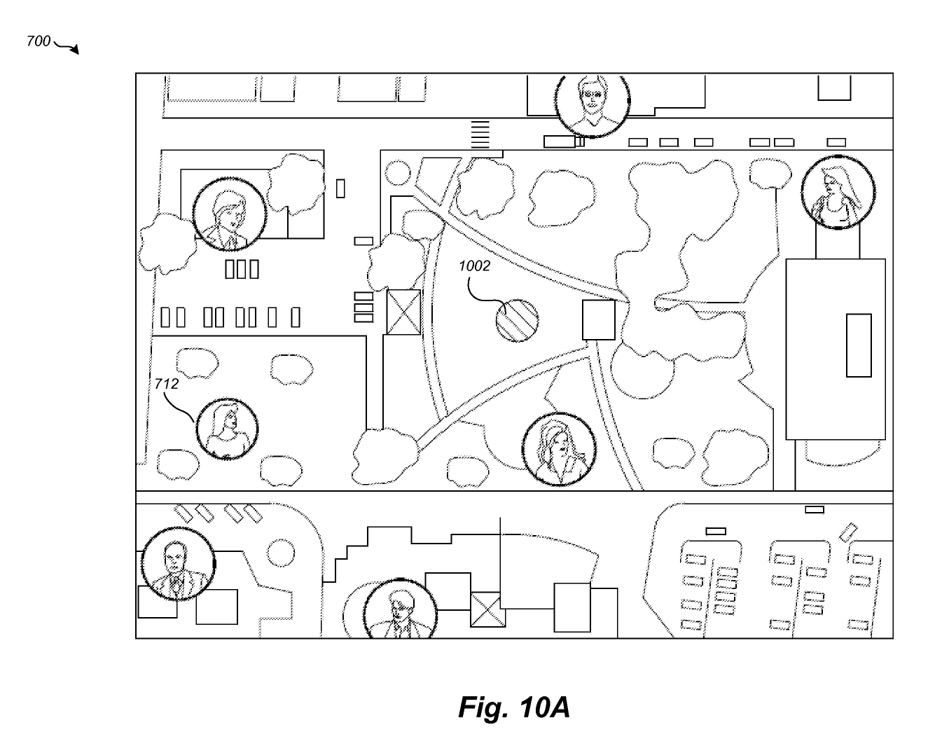

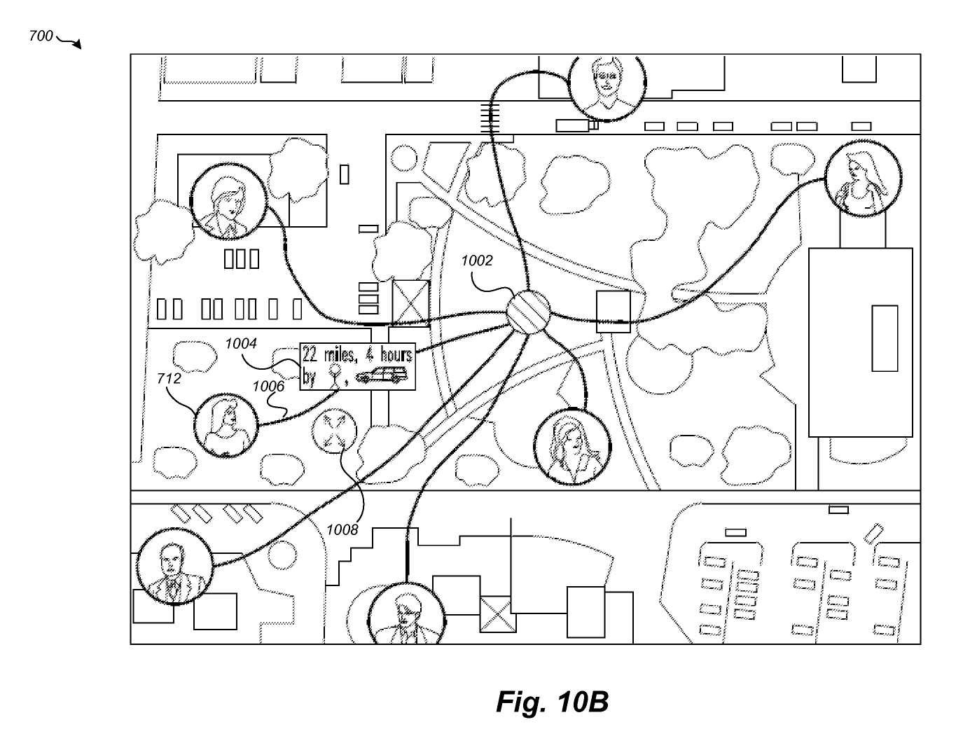

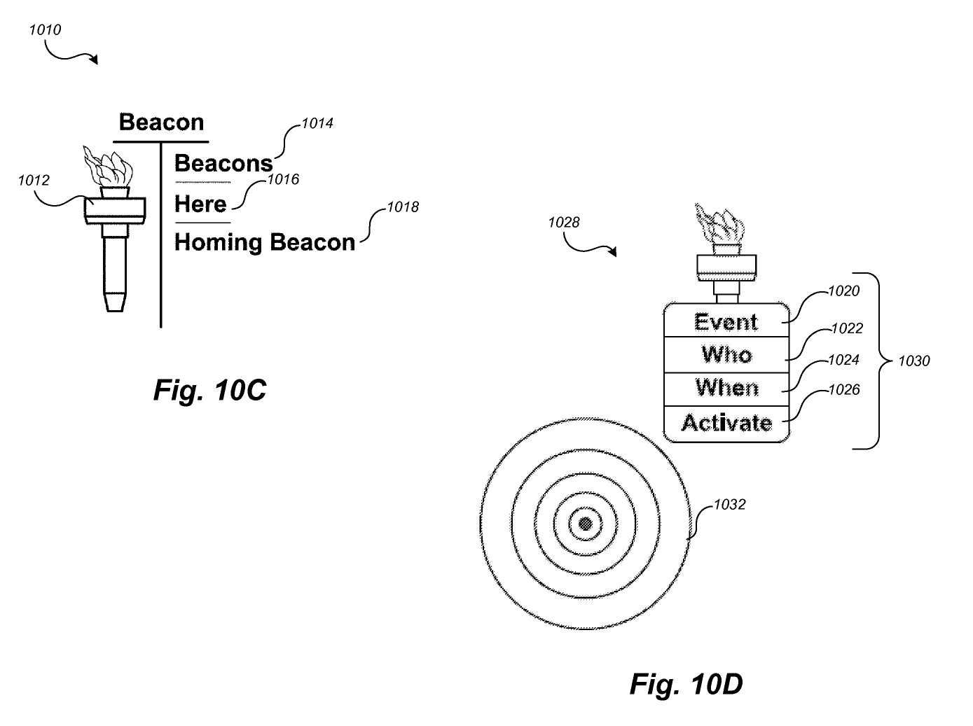

FIG. 10A is a drawing of the example user interface screen of FIG. 7 additionally showing a beacon 1002 set at a selected location on the map 700 at which an event is to occur, according to one illustrated embodiment. This beacon may be set by the user tapping, clicking on or otherwise selecting the desired location on the displayed map. The user may alternatively input an address, location coordinates or otherwise provide input indicating the desired location on the map 700. Once set, information indicative of the selected location is communicated to a plurality of users. For example, the system may use current Global Positioning System (GPS) data and/or functionality of various users' mobile devices to enable the users to share with their friends or contacts their current location in real time or near real time. As shown in FIG. 7 and FIG. 10A, there may be an individual graphical marker for each user that is presented on a map corresponding to the current location of the user's device. For example, in FIG. 10A the interactive graphical marker 712 is presented at a location on the map 700 corresponding to the current physical location of the device of the user represented by the graphical marker 712 based on the associated GPS data and/or other location data. If the location of the device of the user moves, this is shown on the map 700 by the associated graphical marker 712 making corresponding movements on the map 700.

The users to whom the information indicative of the selected location is communicated, for example, may be members of an online social network. In some embodiments, the user may pin an event at specific coordinates on the map 700 with a countdown ticker (not shown) until a meeting time. Simultaneously GPS directions are pushed to the individual users and/or groups of users. For example, the individual users and/or groups of users may be members of the online social network of which the user is also a member that is associated with the system for facilitating location-based social networks described herein. Additionally or alternatively, they may be connections of the user on such a social network or other online social network as defined in the user's account on such social networks, such that the beacon is visible automatically to the user's connections on one or more social network platforms once set by the user.

The user is also able to select users individually or by other criteria. Such criteria may also include selectable default preference settings such that the user does not have to set the same criteria each time a beacon is set by the user. The selection criteria may include, but is not limited to, one or more of: a name, online social network member identification, an email address, a phone number, demographic criteria, criteria based on online social network member profile information, likes of one or more members of the online social network, dislikes of one or more members of the online social network activities of one or more members of the online social network, events that one or more members of the online social network had attended, and interests of one or more members of the online social network.

In some embodiments, a beacon 1002 may appear automatically as a graphic marker on corresponding maps on devices of the users selected to see the beacon or otherwise receive the location information in response to the beacon being set. In some embodiments, the beacon may include a written, voice-recorded, or video description of the event for which people are being beaconed. Beacons may be made public or private.

FIG. 10B is a drawing of the example user interface screen of FIG. 10A additionally showing routes on the map 700 for members of the online social network to take to the location of the beacon 1002 from their current physical locations as indicated on the map 700, according to one illustrated embodiment. For example, route 1006 is shown traveling from the graphical marker 712 at a location on the map 700 corresponding to the physical location of the device of the user represented by the graphical marker 712. This is an example route 1006 for the user to take to the location of the beacon 1002 at which the event is to occur and thus is shown ending at the beacon 1002.

As an example scenario according to one embodiment, when the user beacons other users (referred to as “beaconed” users) on the map 700, the user can see on the map 700 the GPS routes each beaconed user is supposed to take to arrive at the location of the beacon 1002. The user may ask the system for facilitating location-based social networks described herein (via voice, text, menu selection or other input) how long it will take for beaconed user to get from where they are currently located to the location of the beacon 1002. When the user sees on the map 700 beaconed users starting to travel to the location of the beacon 1002, if the user sees a beaconed user is not moving in the correct direction, or in fact hasn't started traveling to the location of the beacon 1002, the user can tap on or otherwise select the interactive graphical marker 712 on the map 700 corresponding to the beaconed user to activate a video chat conversation 904 window, such as that shown in FIG. 7. This initiates a video conversation with the corresponding beaconed user to help the beaconed user or get the beaconed user back on track to the location of the beacon 1002.

When the user calls beaconed user on the map, there may be an option to enter in to a full screen video chat, for example, by selecting a full-screen mode button 1008 displayed on the map 700, or an option to use smaller video chat window which allows the user to see the selected user in the context of the map 700 as shown in video chat conversation window 904 in FIG. 7. By the system enabling the selected user to be viewed in a smaller video chat window 904, the user is able to make reference to the map and the beaconed user's location, as well as give the beaconed user directions based on where the user sees the beaconed user is currently located on the map. The user may also talk to the beaconed user about their surroundings because the user can see things such as landmarks and geographical features depicted on the map 700 relative to the beaconed user's location on the map.

When the user is able to see the proposed route of the beaconed user, which is based on GPS or other location data of the beaconed user and the location at which the beacon 1002 was set, the user is able to notice the names of the streets as the user would if the user was following their own GPS navigation system to a selected destination. The user may also be able to see the estimated time of arrival of the beaconed user(s), the distance the beaconed user(s) are from the location of the beacon 1002, and how long it will take the beaconed user(s) to get to the location by walking, driving, taking a train, etc. Such information may be displayed in real time or near real time on the map 700 such as, for example, by an informative graphical user interface element 1004 shown on the corresponding route on the map 700. In various alternative embodiments, the informative graphical user interface element 1004 may be displayed on the map at different locations on the map 700 than that shown in FIG. 10B or may be otherwise communicated to the user.

In some embodiments, the user may encircle a group of graphical markers representing a group of user locations on the map 700 with the user's finger, or otherwise select connections of the user. The user then places a beacon on the area of the map 700 the user wants the users represented by the encircled group of graphical markers to go. The beacon message and/or applicable GPS directions will then be sent to these users once the beacon is set.

FIG. 10C is a drawing of an example graphical user interface menu element 1010 to facilitate the setting and management of beacons such as the beacon 1002 shown in FIGS. 10A and 10B, according to one illustrated embodiment. Part of the user interface menu element 1010 is a selectable option 1012 to set the beacon manually. For example, the user may press on and drag, or click on and drag, the selectable option 1012 to the desired location on the map 700 shown in FIG. 10A to input the desired location of the beacon 1002. The user may then release and set the beacon by lifting their finger or mouse button once the selectable option 1012 is at the desired location on the displayed map. Also, the user may select a selectable “beacons” option 1014 to see all the beacons that are currently set. The user may select a selectable “here” option 1016 to set a beacon at the user's own current location. Additionally, the user may select a selectable “homing beacon” option 1018 to place a beacon on, or tie a beacon to, a marker displayed on the map representing a device that is able to be tracked by applicable GPS location data or other location data. These may include devices currently moving or capable of becoming mobile (e.g., user's mobile devices, vehicles, etc.).

FIG. 10D is a drawing of an example graphical user interface menu element 1028 including a setup panel 1030 to facilitate the user setting beacons such as the beacon 1002 shown in FIGS. 10A and 10B, according to one illustrated embodiment. For example, after the beacon 1002 is released or set on the map 700 as described above, the setup panel 1030 may automatically be presented on the map 700 or other portion of the graphical user interface. The user may select a selectable “event” option 1020 within the setup panel 1030 to add an event title to the event associated with the beacon 1002 and/or a written, voice and/or video message for the associated event. The user may select a selectable “Who” option 1022 within the setup panel 1030 to activate a list of the user's connections from one or more online social networks of the user to appear, which optionally includes images and names of the connections, as well as an input field to enter in names of selected users for whom the beacon is intended. The user may select a selectable “When” option 1024 within the setup panel 1030 to add a date and time to meet for the event associated with the beacon 1002.

The user may then select a selectable “Activate” option 1026 within the setup panel 1030 to activate the beacon as described above to communicate the location data to the applicable users. According to one embodiment, when the user selects the “Activate” option 1026, a beacon will automatically send a push notification to one or more devices of the users for whom the beacon is intended, and/or a message with GPS directions to the location of the beacon. For example, information indicative of the selected location of the beacon 1002 may be communicated to each user for whom the beacon is intended. Such information may include a link which, when selected, activates one or more navigation systems of one or more devices of the user for whom the beacon is intended to provide navigation particularly to the selected location for that user. This information may be operably communicated, for example, to the in-dash navigation system of a user's vehicle, such as vehicle 106 shown in FIG. 1, and/or to the user's mobile device, such as mobile device 102 shown in FIGS. 1 and 3, such that the navigation system of the vehicle or device may automatically display the GPS directions to the location of the beacon from the current location of the vehicle or device.

In some embodiments, each user for whom the beacon is intended may have a map similar to that of the map 700 shown in FIG. 10B, that is displayed using a similar application running on their mobile device or their in-dash vehicle GPS navigation screen that shows the beacon 1002 at the corresponding location on their map in response to the activation of the beacon 1002 by the user who set the beacon (i.e., the “beaconer”). In some embodiments, the beacon 1002 may be animated and produce outward-moving concentric circles such as concentric circles 1032 shown in FIG. 10D. A countdown ticker (not shown) leading up to the meeting date may also be running and visible on the map 700.

In some embodiments, many users can see and follow a single individual user. There may be a designated follow button presented on a graphical user interface for each graphical marker displayed on the map 700. Even if that individual is traveling at 60 mph, a follower will see the profile image of the one they're following as if stationary in their field of view. In some embodiments, when a person being followed is in motion, only the map 700 would move in the background, and in this way, a follower won't lose sight of the one they're following. A user may also choose to start a one-way, or two-way voice/video broadcast with his/her followers as described herein by selecting the graphical marker displayed on the map 700 representing the user.

Some embodiments may provide a “game-plan” feature. The game-plan feature allows a user to place images, video, messages/text, and/or links on the map 700 the user and/or other users or connections of the user can see. A user can manually draw or write on a map with their finger, a text box, or a stylus device, which other users and/or connections can see in real time.

Referring again to FIG. 10B, the user who set the beaconer will be able to see the specific paths/routes 1006 for each attendee beaconed to the event and can watch as everyone summoned converges at the location of the beacon 1002 as their corresponding graphical markers move on the map 700 corresponding to the direction each user's device or vehicle is traveling. An individual's path may converge with the path of another who is close by; in this way, attendees can meet up with other attendees on the way to the event. In some embodiments, each attendee may have a map similar to that of the map 700 shown in FIG. 10B, that is displayed using a similar application running on their mobile device or their in-dash vehicle navigation screen that shows the graphical markers indicating the physical locations the devices of each of the attendees who were summoned by the same beacon 1002. When a user is beaconed to a location, they can drop out if they wish, and in some embodiments, the graphical marker indicating the location of their device on the map 700 will also be hidden or otherwise discontinue to be shown. There may also be visual indications on or near the graphical markers differentiating which users were beaconed, have opted-in and/or have accepted the beacon and those who were not beaconed, opted-out and/or did not accept the beacon. In some embodiments, if a user sees a beacon on their map 700 as set by the beaconer as public, such that all or a larger group of users can see it, the user can then tap on the beacon or otherwise select it to receive directions and/or event information.

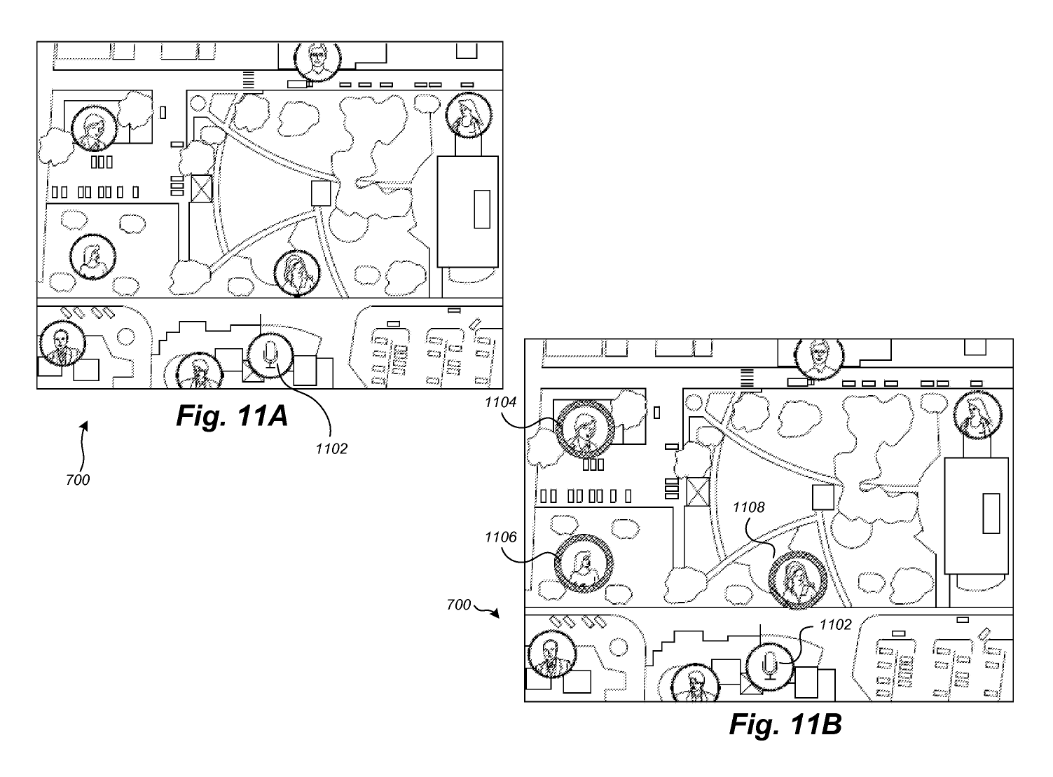

FIG. 11A is a drawing of the example user interface screen of FIG. 7 additionally showing a voice input microphone user interface element 1102 on the map 700 and FIG. 11B is a drawing of the example user interface screen of FIG. 1B additionally showing particular user profile pictures 1104, 1106 and 1108 on the map 700 highlighted to show results of a user query input using voice input, according to one illustrated embodiment. In particular, a user may input search information, terms, keywords or other search criteria by voice using the corresponding microphone of their device or in-dash vehicle communication system to find particular users matching such search criteria. In the example shown in FIG. 11B, the user spoke particular search criteria and the system highlighted the graphical markers 1104, 1106 and 1108 corresponding to users whose information matched the search criteria. Such search criteria may include, but is not limited to, one or more of: a name, online social network member identification, an email address, a phone number, demographic criteria, criteria based on online social network member profile information, likes of one or more members of the online social network, dislikes of one or more members of the online social network activities of one or more members of the online social network, events that one or more members of the online social network had attended, interests of one or more members of the online social network, etc. It is possible to search for other users based on any possible filters. For example if a user asks: “who likes to hike?” or “who wants to go hiking this weekend?” immediately the user would see other users highlighted on the map 700 who have asked similar questions, performed similar searches, or who have other social networking profiles such as Facebook®, Twitter®, Linkedin® or others associated/linked with the social network of the system for facilitating location-based social networks described herein, that may be analyzed or data-mined for information related to a user's search.

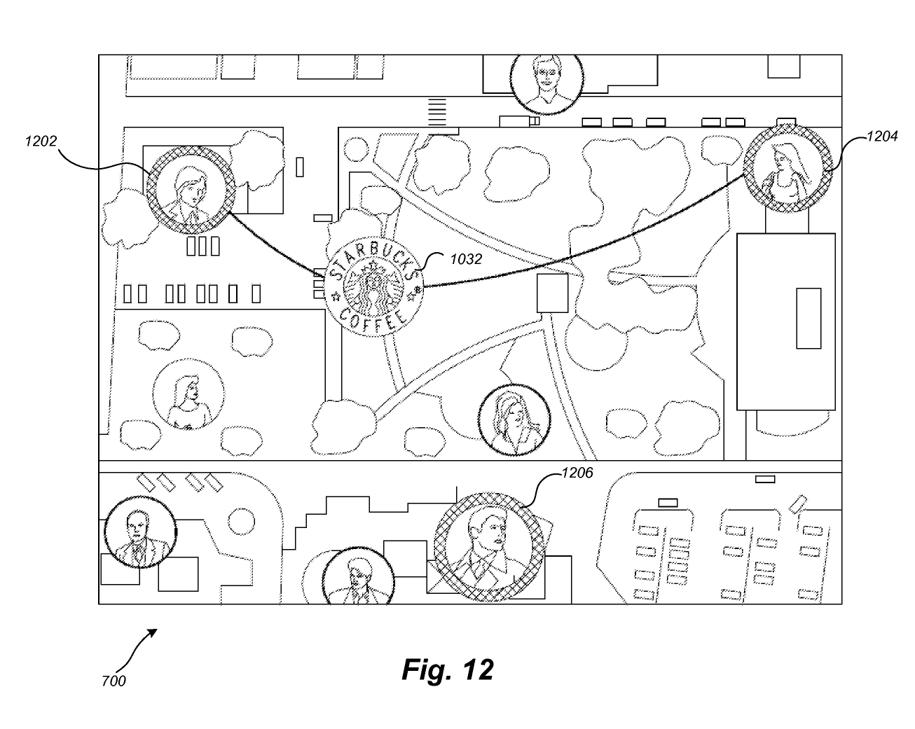

FIG. 12 is a drawing of an example user interface screen having the map 700 shown in FIG. 7 illustrating pairing of two social network members, represented by highlighted graphical markers 1202 and 1204, and a suggested meeting point 1032 on the map 700, according to one illustrated embodiment. The system for facilitating location-based social networks described herein can automatically analyze two user's profiles, or associated profiles on social networks such as Match.com®, LinkedIn®, or Facebook®, and pair two users for a date based on compatibility, similar interests, or value profiles and so on. An appropriate, local business (e.g., a Starbucks® coffee shop) which, in some embodiments, may pay for advertising rights with the system for facilitating location-based social networks described herein will be automatically suggested with a meeting time and GPS directions pushed to each user represented by highlighted graphical markers 1202 and 1204 in a similar fashion as if they were beaconed to the meeting point 1032 by another user as described above. If the location isn't ideal, users can select an “other” option displayed on the graphical user interface which will allow users to flick through and select a location from a list of other, local businesses. The pairing feature can also pair up two or more users who could be potentially good friends, for example the three users represented by highlighted graphical markers 1202, 1204 and 1206.

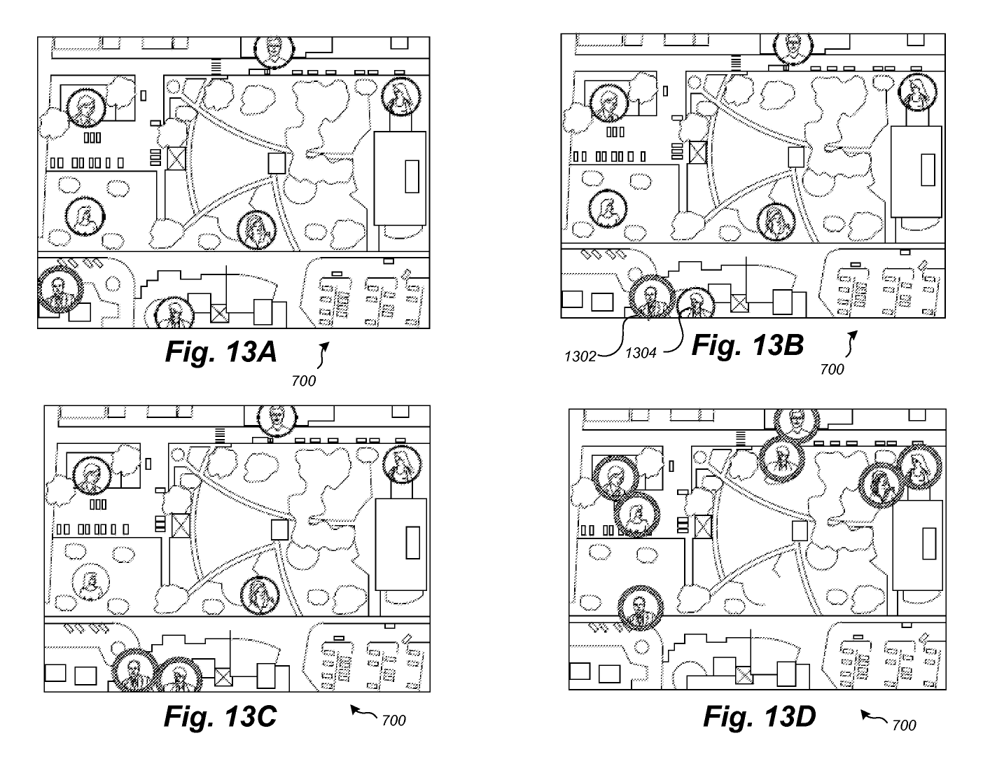

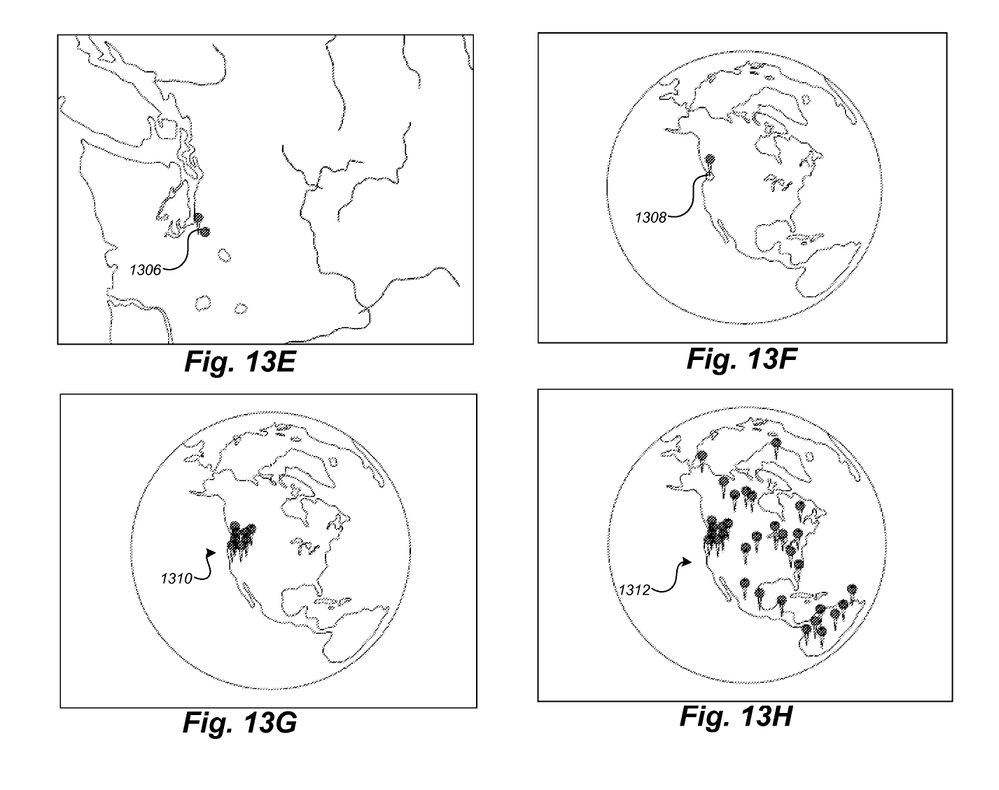

FIGS. 13A-13H are drawings of example user interface screens having the map 700 shown in FIGS. 5-7 illustrating progressive stages of an online game including a plurality of members of the online social network shown on the map 700 as players, according to one illustrated embodiment. The system for facilitating location-based social networks described herein enables people to play games that are location-based. In particular, the system for facilitating location-based social networks described herein may electronically execute one or more online game including the plurality of members of the online social network as players. The game may have rules based on a physical proximity, as depicted on the map 700, of one or more of the plurality of devices of one or more of the plurality of members of the online social network to one or more other devices of the plurality of devices of one or more other members of the plurality of members of the online social network.

For example, “Zombie Run”, “Capture the Flag” and a strategy/war game are each available in various embodiments. In “Zombie Run”, one or more initial players will become “infected” as represented by the “infected” highlighted graphical marker 1302 shown in FIG. 13B and if he or she nears another “uninfected” player for some predetermined distance and time as shown by the graphical marker 1302 near graphical marker 1304 representing the physical location of the “uninfected” player, then the other “uninfected” player will become infected. This process may continue until an entire city 1306, state 1308, region 1310, country 1312 or the planet is infected as shown in FIGS. 13E through 13H. In some embodiments, the last standing player(s) may receive a prize from business advertising with the system for facilitating location-based social networks described herein.

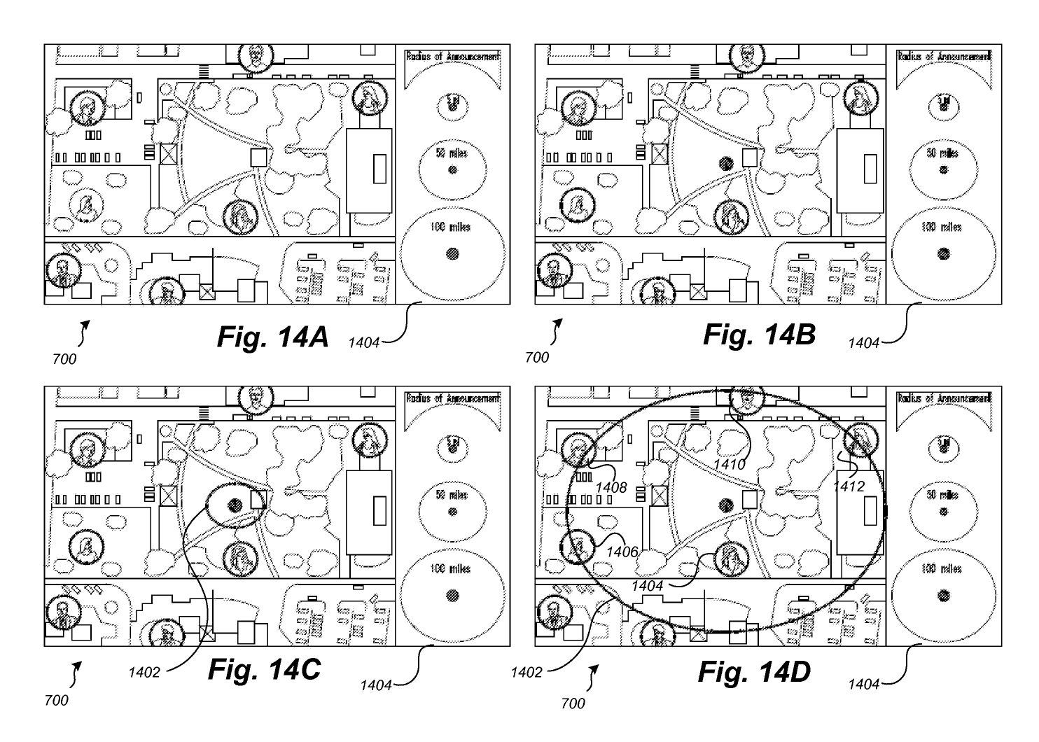

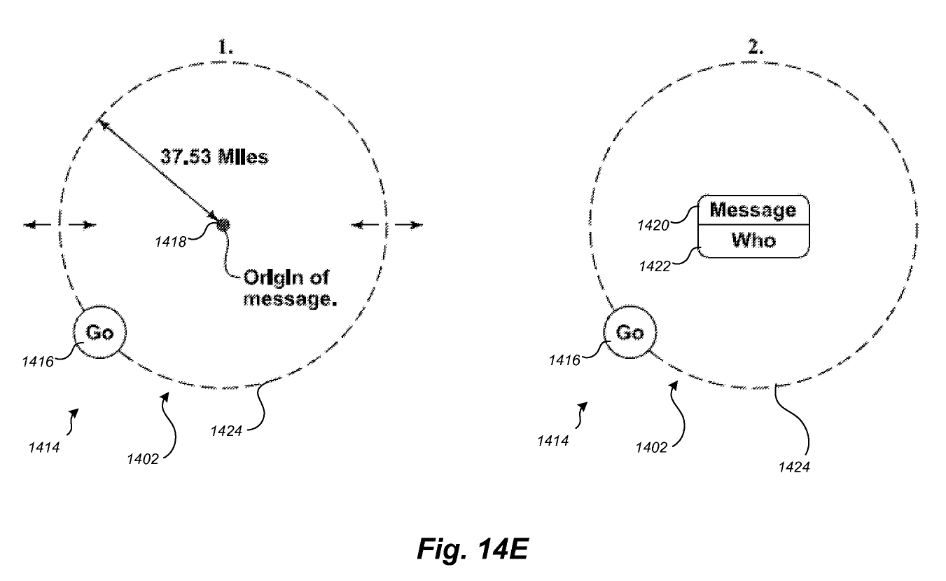

FIGS. 14A-14D are drawings of example user interface screens having the map 700 shown in FIG. 7 illustrating a marker 1402 in FIGS. 14C and 14D expandable by a user on the map 700 to select various members of the online social network shown on the map 700 to whom a message will be broadcast, according to one illustrated embodiment. The system for facilitating location-based social networks described herein presents on the map 700 a marker 1402 expandable by a user. For example, the user may select the marker having an initial radius size from a graphical user interface menu panel 1404 of the user interface screen. As shown in FIG. 14C, the user has selected from the user interface menu panel 1404 a marker 1402 with initial radius size of 5 miles and placed it on a selected location on the map 700. As shown in FIG. 14D, the user has expanded the marker (e.g., by clicking or pressing on and dragging the perimeter of the marker 1402) to increase the size of the radius. The user may similarly contract the radius size of the expandable marker 1402. The system then broadcasts a message to (or selects for some other purpose) each user for which an associated graphical marker representative of the online social network identity of the user is on the map 700 and falls within the marker. In the example shown in FIG. 14D, the message is broadcast to the users represented by graphical markers 1401, 1406, 1408, 1410 and 1412 because each of these graphical markers at least partially fall within the expandable marker 1402 on the map 700.

As one example scenario according to an embodiment, the system for facilitating location-based social networks described herein enables a user to pin a location on the map 700 and emanate a message from the coordinates with an expandable ring of communication designated by marker 1402 that can increase or decrease with area. As the ring designated by marker 1402 is expanded, every user falling within the area of the ring will be notified of the announcement once it is activated. The announcement may be in the form of a text, voice-recording, video recording, including links, descriptions, or some combination of these.

FIG. 14E is a drawing of an example user interface element 1414 including the marker 1402 expandable by a user, such as that shown on the map 700 in FIGS. 14C and 14D, according to one illustrated embodiment. In the present example embodiment, the marker 1402 is in the form of an expandable broadcast ring 1424. The broadcast ring 1424 can be dragged and dropped/pinned onto the map 700 from the user interface menu panel 1404 shown in FIGS. 14A-14D, or generated through the user making gestures on the map 700 via a touch screen or mouse, etc., such as by the user drawing a circle on the map 700 with the user's finger. Pressing the “Go” button on the broadcast ring 1424 then initiates sending of the broadcast message falling within the broadcast ring 1424 on the map 700.

In some embodiments, the user can add a title and a textual, voice and/or video message, and photos, videos and or links as part the message by selecting the “message” button 1420, which may be located inside or near the broadcast ring 1402. By the user selecting the “Who” button 1422, it will cause a drop-down contacts list of the user from the online social network of the system described herein and/or of other online social networks associated with the user, from which the user can select people to whom the broadcast message is to be sent, even if they are not within the vicinity or within the location designated within the broadcast ring 1424 on the map 700. A textual input field may also be provided for the user to manually input names or other search criteria of people to whom the user wants to broadcast message to be sent, even if they are not within the vicinity or within the location designated within the “broadcast ring” 1424 on the map 700.

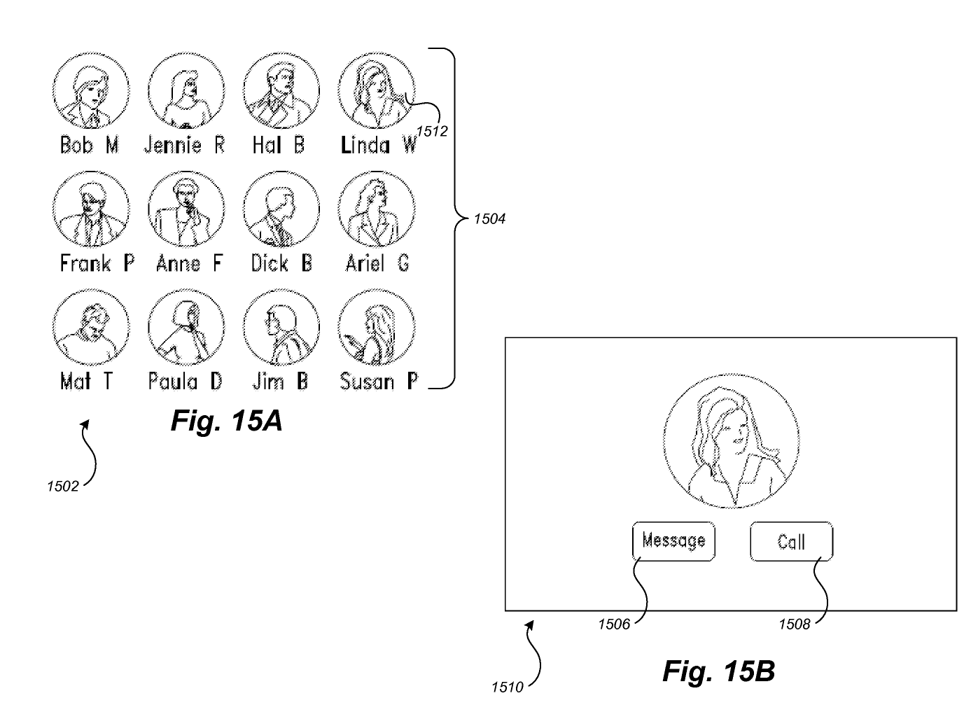

FIG. 15A is a drawing of an example user interface element 1502 illustrating selectable profile pictures of various members of an online social network, according to one illustrated embodiment. The user interface element 1502 includes a matrix of profile photos 1504 of connections of the user. When the user wishes to speak to a connection, the user can simply tap on the image of the connection which then transforms into two buttons: a “message” button 1506 and a “call” button 1508 as shown in FIG. 15B. In particular, FIG. 15B is a drawing of an example graphical user interface element 1510 that may appear after selection of one of selectable profile pictures in the matrix 1504 shown in FIG. 15A, according to one illustrated embodiment. In the present example, the user had selected profile picture 1512 resulting in the graphical user interface element 1510 appearing. Group messaging and group video calling is also possible.

Overall, the “friends list” feature shown in FIGS. 15A and 15B enables the user to see all of the user's connections within the online social network of the system for facilitating location-based networks described herein and/or of other online social networks associated with the user, and enables the user to connect with them easily. For example, the connections' profile photos are displayed in a compact, matrix format 1504. When a user taps or otherwise selects a profile photo, a video-chat conversation may be immediately initiated, and there is presented an option for the user to message the user's contacts. If the user wants to have a conference call with many other users, the user then taps on the profile pictures of the people with whom the user wants to meet and a group or conference video chat is simultaneously created where all the selected users can see and hear everyone else in real time.

If the user has pre-defined groups with whom the user wants to meet frequently, the user can tap on the group in this mode and immediately initiate a conference call with everyone in the group, which is faster than individually tapping on each contact to join a conference call. For example, if the user has a regular meeting every Friday night with the user's bible-study group, the user can pre-program the date and time and be able to receive an increasing number of notifications about the user's scheduled video chat conference as the meeting time approaches. Furthermore a regular or scheduled video-conference can be automatically initiated at a designated time if the user has programmed the feature into the user's video settings in the system for facilitating location-based networks described herein.

A visibility feature of the system for facilitating location-based networks described herein may include a list of privacy features which allows a user to articulate the level of visibility the user will have within the system for facilitating location-based networks described herein. For example, a user may want to be visible on the map 700 only within a one mile radius of their location, or only to their friends and family as defined in their online social media account, or to everyone, etc.

In some embodiments, when a user is near one or more of the user's connections, the user will be notified by the system vibrating the user's phone or making a sound with a push notification that may look something similar to: “John Doe is close to you, would you like to meet at Starbucks, or another location?” If the user selects other, then the user will be able to select from a list of other local businesses to meet up at, but if the user selects yes, then they will immediately be given GPS directions to the location. The system for facilitating location-based networks described herein can place a virtual beacon on the map 700 at the business location with a radius scaled for the business to determine when the users have entered the business location. Then, for example, after 5-10 minutes of being at the business location, a graphical user interface screen with 5 stars and the business name and location will resolve on the user's mobile device display 304 and the user can then rate the business and or leave a comment.

Beacons as described herein allow for retailers to push vouchers, news, deals, (perhaps even professionally photographed images of products can assimilate on the user's mobile device lock-screen) and notifications about free items to nearby users of the retailers' mobile applications. Many business owners do not have the money or knowledge to get a tailor-made mobile application for their business. These businesses may use beacons as described herein to virtually advertise through system for facilitating location-based networks described herein. In this way, when a user is walking down the street near a business location such as Dunkin Donuts®, for example, the user may receive a push notification about free donuts that the business has to get rid of before the end of the day, or a buy one get one free deal, etc. The pair feature described in conjunction with FIG. 12 also serves as an advertising tool in various embodiments, by automatically locating a nearby place for two or more users to meet.

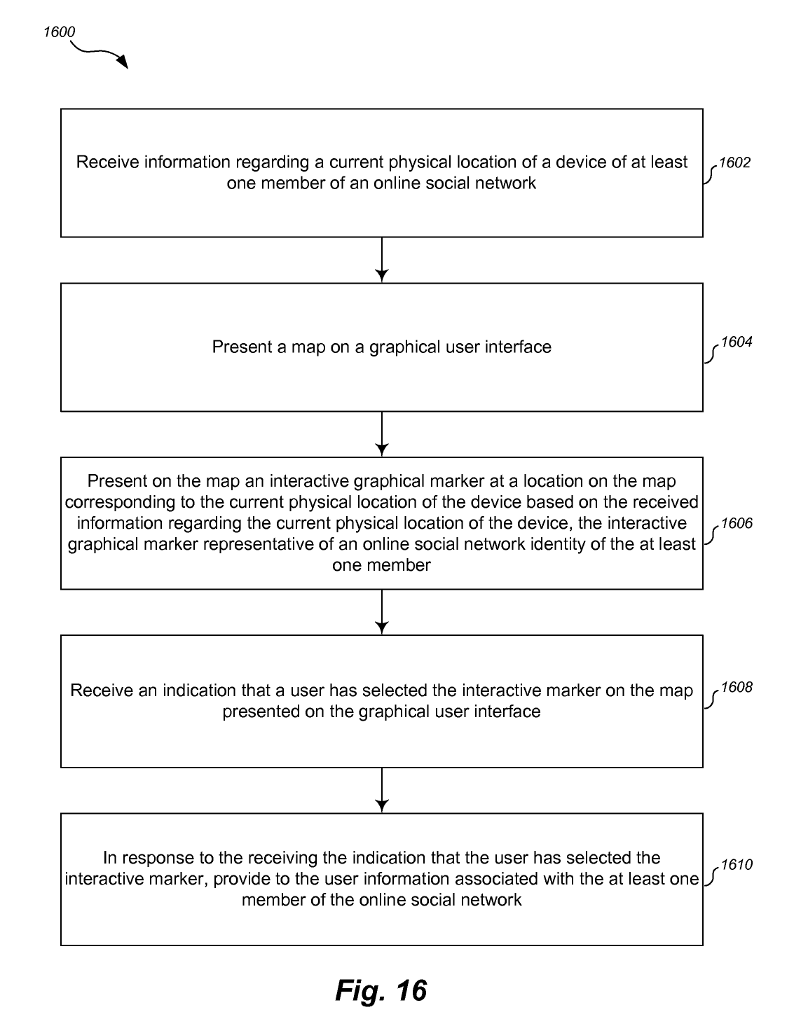

FIG. 16 is a flow diagram showing a method 1600 for providing information associated with members of an online social network in a system for facilitating location-based social networks, according to one illustrated embodiment.

At 1602, the system for facilitating location-based social networks receives information regarding a current physical location of a device of at least one member of an online social network.

At 1604, the system for facilitating location-based social networks presents a map on a graphical user interface.

At 1606, the system for facilitating location-based social networks presents on the map an interactive graphical marker at a location on the map corresponding to the current physical location of the device based on the received information regarding the current physical location of the device. The interactive graphical marker is representative of an online social network identity of the at least one member.

At 1608, the system for facilitating location-based social networks receives an indication that a user has selected the interactive marker on the map presented on the graphical user interface.

At 1610, the system for facilitating location-based social networks, in response to the receiving the indication that the user has selected the interactive marker, provides to the user information associated with the at least one member of the online social network.

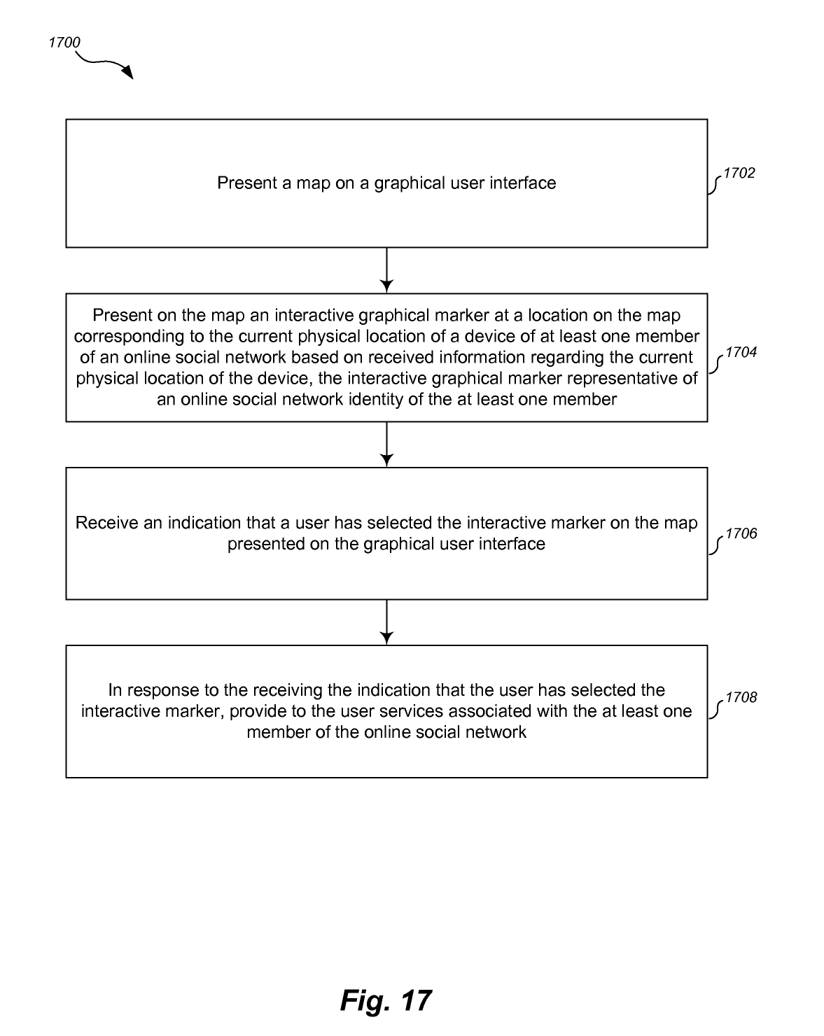

FIG. 17 is a flow diagram showing a method 1700 for providing services associated with members of an online social network in a system for facilitating location-based social networks, according to another illustrated embodiment.

At 1702, the system for facilitating location-based social networks presents a map on a graphical user interface.

At 1704, the system for facilitating location-based social networks presents on the map an interactive graphical marker at a location on the map corresponding to the current physical location of a device of at least one member of an online social network based on received information regarding the current physical location of the device. The interactive graphical marker is representative of an online social network identity of the at least one member.

At 1706, the system for facilitating location-based social networks receives an indication that a user has selected the interactive marker on the map presented on the graphical user interface.

At 1708, the system for facilitating location-based social networks, in response to the receiving the indication that the user has selected the interactive marker, provides to the user services associated with the at least one member of the online social network.

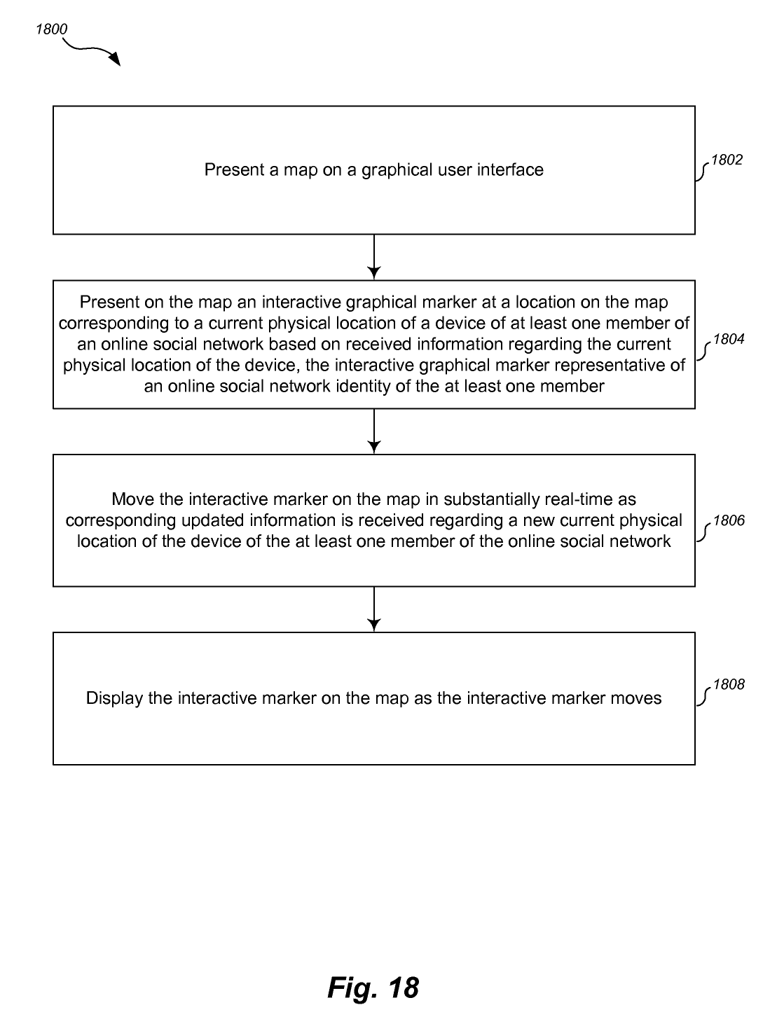

FIG. 18 is a flow diagram showing a method 1800 for presenting interactive graphical markers on locations on a map corresponding to current physical locations of devices of members of an online social network in a system for facilitating location-based social networks, according to another illustrated embodiment.

At 1802, the system for facilitating location-based social networks presents a map on a graphical user interface.

At 1804, the system for facilitating location-based social networks presents on the map an interactive graphical marker at a location on the map corresponding to a current physical location of a device of at least one member of an online social network based on received information regarding the current physical location of the device. The interactive graphical marker is representative of an online social network identity of the at least one member.

At 1806, the system for facilitating location-based social networks moves the interactive marker on the map in substantially real time as corresponding updated information is received regarding a new current physical location of the device of the at least one member of the online social network.

At 1808, the system for facilitating location-based social networks displays the interactive marker on the map as the interactive marker moves.

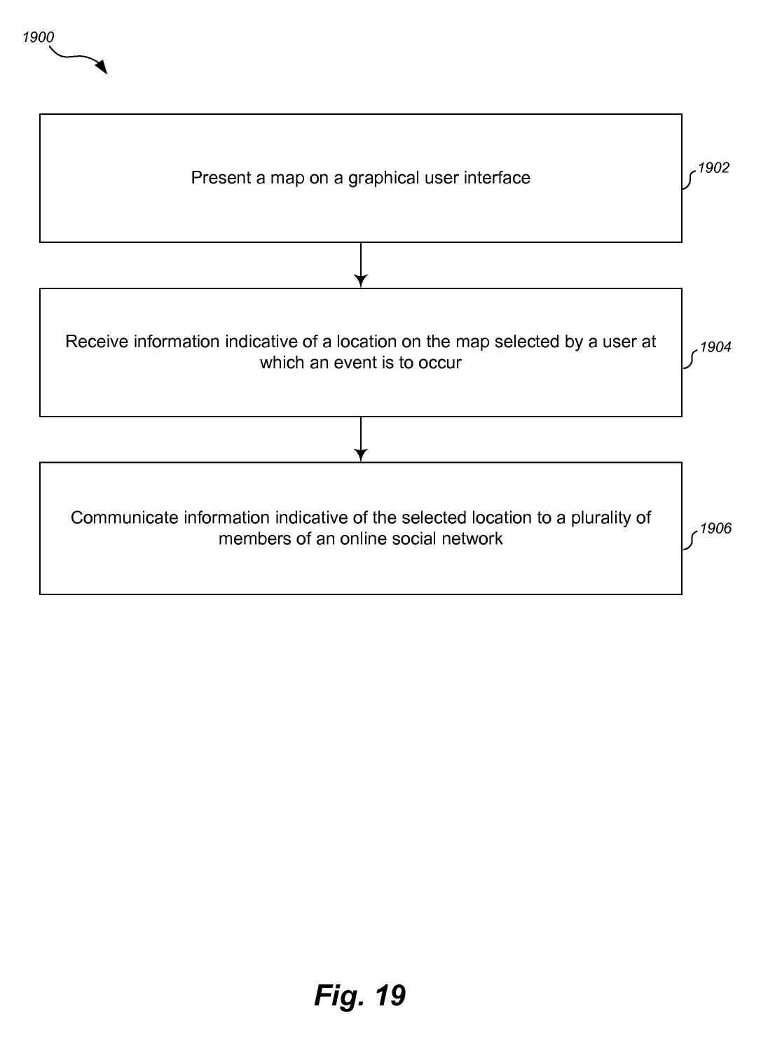

FIG. 19 is a flow diagram showing a method 1900 for providing a beacon to members of an online social network in a system for facilitating location-based social networks, according to another illustrated embodiment.

At 1902, the system for facilitating location-based social networks presents a map on a graphical user interface.

At 1904, the system for facilitating location-based social networks receives information indicative of a location on the map selected by a user at which an event is to occur.

At 1906, the system for facilitating location-based social networks communicates information indicative of the selected location to a plurality of members of an online social network.

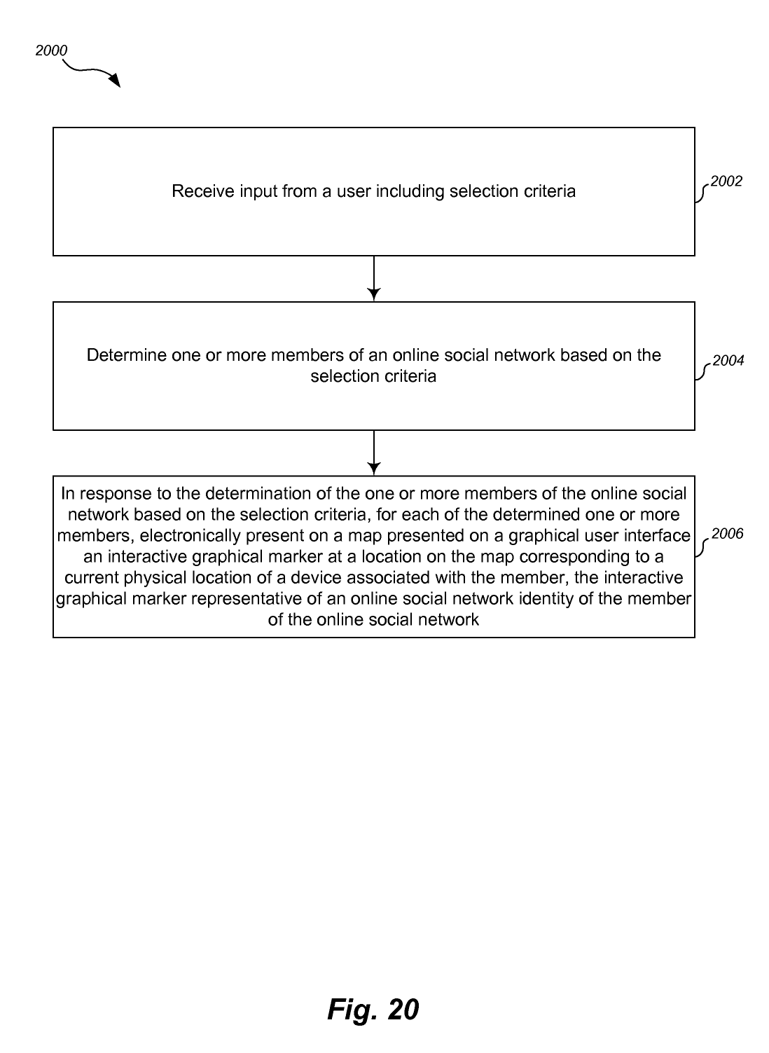

FIG. 20 is a flow diagram showing a method 2000 for indicating on a map the current location of selected members of an online social network in a system for facilitating location-based social networks, according to another illustrated embodiment.

At 2002, the system for facilitating location-based social networks receives input from a user including selection criteria.

At 2004, the system for facilitating location-based social networks determines one or more members of an online social network based on the selection criteria.

At 2006, the system for facilitating location-based social networks, in response to the determination of the one or more members of the online social network based on the selection criteria, for each of the determined one or more members, presents on a map presented on a graphical user interface an interactive graphical marker at a location on the map corresponding to a current physical location of a device associated with the member. The interactive graphical marker is representative of an online social network identity of the member of the online social network.

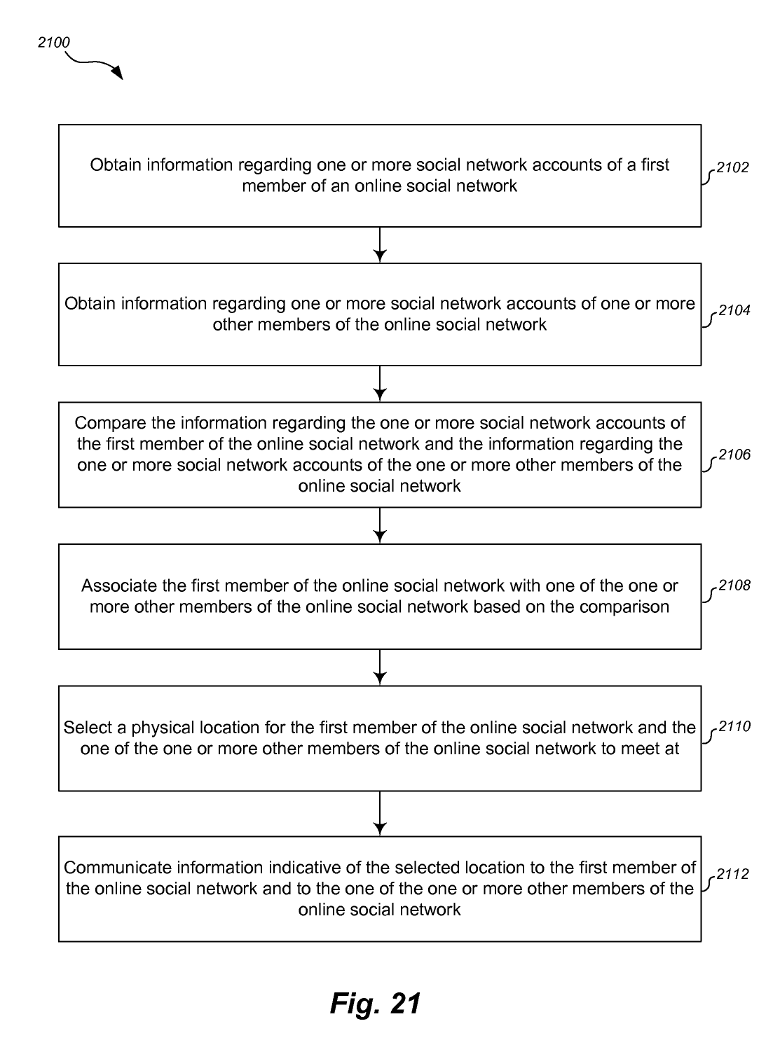

FIG. 21 is a flow diagram showing a method 2100 for pairing two members of an online social network in a system for facilitating location-based social networks, according to another illustrated embodiment.

At 2102, the system for facilitating location-based social networks obtains information regarding one or more social network accounts of a first member of an online social network.

At 2104, the system for facilitating location-based social networks obtains information regarding one or more social network accounts of one or more other members of the online social network.

At 2106, the system for facilitating location-based social networks compares the information regarding the one or more social network accounts of the first member of the online social network and the information regarding the one or more social network accounts of the one or more other members of the online social network.

At 2108, the system for facilitating location-based social networks associates the first member of the online social network with one of the one or more other members of the online social network based on the comparison.

At 2110, the system for facilitating location-based social networks selects a physical location for the first member of the online social network and the one of the one or more other members of the online social network to meet at.

At 2112, the system for facilitating location-based social networks communicates information indicative of the selected location to the first member of the online social network and to the one of the one or more other members of the online social network.

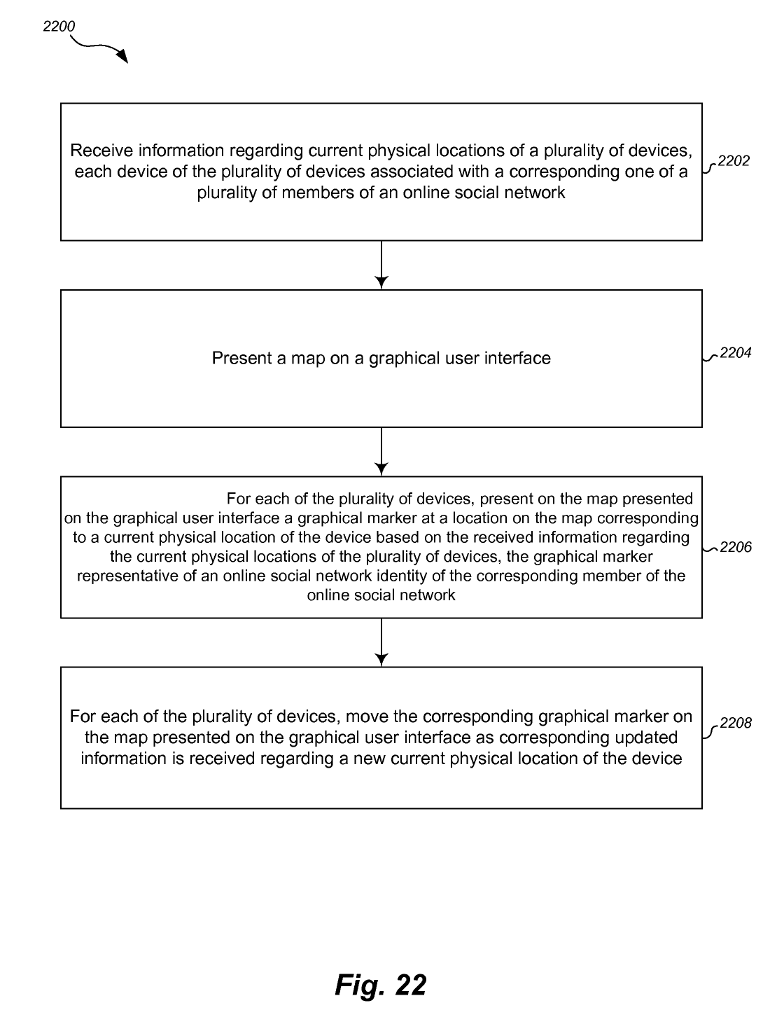

FIG. 22 is a flow diagram showing a method 2200 for moving on a map the indications of the current locations of members of an online social network as their locations change in a system for facilitating location-based social networks, according to another illustrated embodiment.

At 2202, the system for facilitating location-based social networks receives information regarding current physical locations of a plurality of devices, each device of the plurality of devices associated with a corresponding one of a plurality of members of an online social network.

At 2204, the system for facilitating location-based social networks presents a map on a graphical user interface.

At 2206, the system for facilitating location-based social networks, for each of the plurality of devices, presents on the map presented on the graphical user interface a graphical marker at a location on the map corresponding to a current physical location of the device based on the received information regarding the current physical locations of the plurality of devices. The graphical marker is representative of an online social network identity of the corresponding member of the online social network.

At 2208, the system for facilitating location-based social networks, for each of the plurality of devices, moves the corresponding graphical marker on the map presented on the graphical user interface as corresponding updated information is received regarding a new current physical location of the device.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary communication vehicles generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or various combinations thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as various combinations thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, flash drives, solid state drives, and computer memory; and other non-transitory computer-readable storage media.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by at least one machine for facilitating location-based social networks, the method comprising:
electronically receiving, by at least one communications component of the at least one machine for facilitating location-based social networks, information regarding a current physical location of a device of at least one member of an online social network;
electronically presenting, by at least one processor of the at least one machine for facilitating location-based social networks, a map on a graphical user interface;
electronically presenting on the map presented on the graphical user interface, by at least one processor of the at least one machine for facilitating location-based social networks, an interactive graphical marker at a location on the map corresponding to the current physical location of the device based on the received information regarding the current physical location of the device, the interactive graphical marker representative of an online social network identity of the at least one member;
electronically receiving, by at least one processor of the at least one machine for facilitating location-based social networks, an indication that a user has selected the interactive marker on the map presented on the graphical user interface; and
in response to the receiving the indication that the user has selected the interactive marker, electronically providing to the user, by at least one processor of the at least one machine for facilitating location-based social networks, information associated with the at least one member of the online social network.

2. The method of claim 1, further comprising:
moving, by at least one processor of the at least one machine for facilitating location-based social networks, the interactive marker on the map presented on the graphical user interface in substantially real time as corresponding updated information is received by the at least one communications component regarding a new current physical location of the device of the at least one member of the online social network, wherein the interactive marker is displayed on the map by at least one processor as the interactive marker moves.

3. The method of claim 2, wherein the corresponding updated information received by the at least one communications component is based on global positioning system (GPS) information regarding a current location of the device of the at least one member of the online social network.

4. The method of claim 1, further comprising:
in response to the receiving the indication that the user has selected the interactive marker presented on the map, initiating activation of an online video conference session between the user and the at least one member.

5. The method of claim 4 wherein the initiating activation of the online video conference session includes:
graphically transforming the interactive marker presented on the map to an online video conference session window located on the map at the location of the interactive marker on the map.

6. The method of claim 5 wherein the indication that the user has selected the interactive marker presented on the map is an indication that the user has touched a location on a touch screen at which the interactive marker is presented.

7. The method of claim 1, further comprising:
electronically receiving, by at least one communications component of the at least one machine for facilitating location-based social networks, information regarding current physical locations of a plurality of devices, each of the plurality of devices associated with a corresponding one of a plurality of members of an online social network; and
for each of the plurality of devices, electronically presenting on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network.

8. The method of claim 7, further comprising:
electronically receiving, by at least one processor of the at least one machine for facilitating location-based social networks, one or more indications that a user has selected multiple interactive markers presented on the map, the selected interactive markers representative of different online social network identities of corresponding members of the online social network; and
in response to the receiving the one or more indications that the user has selected multiple interactive markers presented on the map, initiating activation of a group online video conference session including the user and the corresponding members of the online social network of which the selected interactive markers are representative.

9. The method of claim 1 wherein the interactive graphical marker includes an image of the at least one member of which the interactive graphical marker is representative.

10. The method of claim 1, further comprising:
electronically receiving, by at least one communications component of the at least one machine for facilitating location-based social networks, an indication that a user has selected to zoom in on the map presented on the graphical user interface; and
in response to the received indication that the user has selected to zoom in on the map presented on the graphical user interface, electronically presenting, by at least one processor of the at least one machine for facilitating location-based social networks, an enlarged section of the map on the graphical user interface including a plurality of interactive graphical markers on the enlarged section of the map, each interactive graphical marker of the plurality of interactive graphical markers being at a location on the enlarged section of the map corresponding to a physical location of a corresponding device of a member of the online social network identified by the interactive graphical marker.

11. The method of claim 10, further comprising:
electronically receiving, by at least one communications component of the at least one machine for facilitating location-based social networks, an indication that a user has selected to zoom out on the map presented on the graphical user interface; and
in response to the received indication that the user has selected to zoom out on the map presented on the graphical user interface, electronically presenting, by at least one processor of the at least one machine for facilitating location-based social networks, a zoomed-out version of the map presented on the graphical user interface including additional surrounding area and an additional plurality of interactive graphical markers on the zoomed-out version of the map, each interactive graphical marker of the additional plurality of interactive graphical markers being shown at a location in the surrounding area on the zoomed-out version of the map corresponding to a physical location of a corresponding device of a member of the online social network identified by the interactive graphical marker.

12. The method of claim 1 wherein the information associated with the at least one member of the online social network that is provided to the user in response to the receiving the indication that the user has selected the interactive marker includes online social network profile information of the member of the online social network.

13. The method of claim 1 wherein the information associated with the at least one member of the online social network that is provided to the user in response to the receiving the indication that the user has selected the interactive marker includes information enabling the user to communicate with the member of the online social network.

14. A system for facilitating location-based social networks comprising:
at least one communications component of at least one machine for facilitating location-based social networks that receives information regarding a current physical location of a device of at least one member of an online social network;
at least one processor coupled to the at least one communications component; and
at least one non-transitory computer-readable storage medium coupled to the at least one processor, the at least one non-transitory computer readable storage medium having computer executable instructions stored thereon that, when executed by the at least one processor, cause the at least one processor to:
electronically present a map on a graphical user interface;
electronically present on the map presented on the graphical user interface an interactive graphical marker at a location on the map corresponding to the current physical location of the device based on received information regarding the current physical location of the device, the interactive graphical marker representative of an online social network identity of the at least one member;
be able to electronically receive an indication that a user has selected the interactive marker on the map presented on the graphical user interface; and
in response to the receiving the indication that the user has selected the interactive marker, electronically provide to the user services associated with the at least one member of the online social network.

15. The system of claim 14, wherein the computer executable instructions, when executed by the at least one processor, further cause the at least one processor to:
move the interactive marker on the map presented on the graphical user interface in substantially real time as corresponding updated information is received by the at least one communications component regarding a new current physical location of the device of the at least one member of the online social network, wherein the computer executable instructions, when executed by the at least one processor, further cause the at least one processor to display the interactive marker on the map as the interactive marker moves.

16. The system of claim 15, wherein the received corresponding updated information is based on global positioning system (GPS) information regarding a current location of the device of the at least one member of the online social network.

17. The system of claim 14, wherein the computer executable instructions, when executed by the at least one processor, further cause the at least one processor to:
in response to the receiving the indication that the user has selected the interactive marker presented on the map, cause an initiation of an online video conference session between the user and the at least one member.

18. The system of claim 17 wherein the initiation of the online video conference session includes a graphical transformation of the interactive marker presented on the map to an online video conference session window located on the map at the location of the interactive marker on the map.

19. The system of claim 18 wherein the indication that the user has selected the interactive marker presented on the map is an indication that the user has touched a location on a touch screen at which the interactive marker is presented.

20. The system of claim 14, wherein the computer executable instructions, when executed by the at least one processor, further cause the at least one processor to:
cause the at least one communications component to be able to electronically receive information regarding current physical locations of a plurality of devices, each of the plurality of devices associated with a corresponding one of a plurality of members of an online social network; and
for each of the plurality of devices, electronically present on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network.

21. The system of claim 20, wherein the computer executable instructions, when executed by the at least one processor, further cause the at least one processor to:
be able to electronically receive one or more indications that a user has selected multiple interactive markers presented on the map, the selected interactive markers representative of different online social network identities of corresponding members of the online social network; and
in response to the receiving the one or more indications that the user has selected multiple interactive markers presented on the map, initiate a group online video conference session including the user and the corresponding members of the online social network of which the selected interactive markers are representative.

22. The system of claim 14 wherein the interactive graphical marker includes an image of the at least one member of which the interactive graphical marker is representative.

23. The system of claim 14, wherein the computer executable instructions, when executed by the at least one processor, further cause the at least one processor to:
cause the at least one communications component to be able to electronically receive an indication that a user has selected to zoom in on the map presented on the graphical user interface; and
in response to the received indication that the user has selected to zoom in on the map presented on the graphical user interface, electronically present an enlarged section of the map on the graphical user interface including a plurality of interactive graphical markers on the enlarged section of the map, each interactive graphical marker of the plurality of interactive graphical markers being at a location on the enlarged section of the map corresponding to a physical location of a corresponding device of a member of the online social network identified by the interactive graphical marker.

24. The system of claim 23 wherein the computer executable instructions, when executed by the at least one processor, further cause the at least one processor to:
be able to electronically receive an indication that a user has selected to zoom out on the map presented on the graphical user interface; and
in response to the received indication that the user has selected to zoom out on the map presented on the graphical user interface, electronically present a zoomed-out version of the map presented on the graphical user interface including additional surrounding area and an additional plurality of interactive graphical markers on the zoomed-out version of the map, each interactive graphical marker of the additional plurality of interactive graphical markers being shown at a location in the surrounding area on the zoomed-out version of the map corresponding to a physical location of a corresponding device of a member of the online social network identified by the interactive graphical marker.

25. The system of claim 14 wherein the services associated with the at least one member of the online social network that is provided to the user in response to the receiving the indication that the user has selected the interactive marker includes communications services for communication with the member of the online social network by the user.

26. The system of claim 14 wherein the services associated with the at least one member of the online social network that is provided to the user in response to the receiving the indication that the user has selected the interactive marker includes selection of the member of the online social network for inclusion in a subgroup of members of the online social network.

27. A non-transitory computer-readable storage medium having computer-executable instructions stored thereon that, when executed by at least one processor of a computer system, causes the at least one computer system to:
electronically present a map on a graphical user interface of the computer system;
electronically present on the map presented on the graphical user interface an interactive graphical marker at a location on the map corresponding to a current physical location of a device of at least one member of an online social network based on received information regarding the current physical location of the device, the interactive graphical marker representative of an online social network identity of the at least one member; and
move the interactive marker on the map presented on the graphical user interface in substantially real time as corresponding updated information is received regarding a new current physical location of the device of the at least one member of the online social network, wherein the computer executable instructions, when executed by the at least one processor, further cause the at least one processor to display the interactive marker on the map as the interactive marker moves.

28. The non-transitory computer-readable storage medium of claim 27 wherein the computer system is a mobile device.

29. The non-transitory computer-readable storage medium of claim 27, wherein the received corresponding updated information is based on global positioning system (GPS) information regarding a current location of the device of the at least one member of the online social network.

30. The non-transitory computer-readable storage medium of claim 27, wherein the computer executable instructions, when executed by the at least one processor, further cause the at least one processor to:
in response to the receiving an indication that a user has selected the interactive marker presented on the map, cause an initiation of an online video conference session between the user and the at least one member.

31. A method performed by at least one machine for facilitating location-based social networks, the method comprising:
electronically presenting to a user, by at least one processor of the at least one machine for facilitating location-based social networks, a map on a graphical user interface;
electronically receiving, by at least one processor of the at least one machine for facilitating location-based social networks, information indicative of a location on the map selected by the user at which an event is to occur; and
electronically communicating, by the at least one processor of the at least one machine for facilitating location-based social networks, information indicative of the selected location to a plurality of members of an online social network.

32. The method of claim 31 wherein the electronically communicating information indicative of the selected location to a plurality of members of the online social network is in response to the receiving the information indicative of a location on the map selected by the user at which the event is to occur.

33. The method of claim 32, wherein the electronically communicating information indicative of the location to a plurality of members of an online social network includes:
selecting, by the at least one processor, the plurality of members of the online social network to whom to communicate the information indicative of the location based on individual associations between the user and the plurality of members as defined in an account of the user on the online social network.

34. The method of claim 33 wherein the selecting the plurality of members includes:
determining, by the at least one processor, members of the online social network who are friends of the user as defined in the account of the user on the online social network; and
electronically communicating, by the at least one processor of the at least one machine for facilitating location-based social networks, the information indicative of the selected location to the members determined to be friends of the user.

35. The method of claim 31 further comprising:
in response to the receiving the information indicative of the location on the map selected by the user at which the event is to occur, electronically presenting to the user, by at least one processor of the at least one machine for facilitating location-based social networks, a menu enabling the user to select the plurality of members of the online social network to whom the information indicative of the location is to be communicated.

36. The method of claim 31 further comprising:
electronically presenting on the map presented on the graphical user interface, by at least one processor of the at least one machine for facilitating location-based social networks, a graphical marker at a location on the map corresponding to the location on the map selected by the user at which an event is to occur.

37. The method of claim 36 further comprising:
electronically receiving, by at least one communications component of the at least one machine for facilitating location-based social networks, information regarding current physical locations of a plurality of devices, each of the plurality of devices associated with a corresponding member of the plurality of members of the online social network to whom the information indicative of the location had been communicated; and
for each device of the plurality of devices, electronically presenting on the map presented on the graphical user interface, by at least one processor of the at least one machine for facilitating location-based social networks, a graphical marker at a location on the map corresponding to a current physical location of the device based on the received information regarding the current physical locations of the plurality of devices, the graphical marker representative of an online social network identity of the corresponding member of the online social network associated with the device.

38. The method of claim 37 further comprising:
for each device of the plurality of devices, updating a location on the map of the graphical marker corresponding to a current physical location of the device in substantially real time as corresponding updated information is received regarding the current physical locations of the plurality of devices.

39. The method of claim 37 further comprising:
for each device of the plurality of devices, showing a path on the map that the device is travelling substantially in real time as corresponding updated information is received regarding the current physical locations of the plurality of devices.

40. The method of claim 37 wherein the at least one of the plurality of devices is a mobile communications device or a vehicle.

41. The method of claim 36, wherein the electronically communicating information indicative of the location to a plurality of members of an online social network includes:
receiving input indicative of a selection of an area on the map by the user; and
selecting, by the at least one processor, each member of the online social network, for which an associated graphical marker representative of the online social network identity of the member is on the map and falls within the selected area, as one of the plurality of members of the online social network to whom to communicate the information indicative of the location.

42. The method of claim 36 further comprising:
in response to the electronically receiving the information indicative of the location on the map selected by the user at which an event is to occur, electronically presenting on the map, by at least one processor of the at least one machine for facilitating location-based social networks, a menu located on or next to the graphical marker on the map enabling the user to provide information regarding the event including one or more of: a written description of the event, a voice-recorded description of the event and a video description of the event; and
electronically communicating, by the at least one processor of the at least one machine for facilitating location-based social networks, the information regarding the event to the plurality of members of the online social network.

43. The method of claim 42 wherein the menu located on or next to the graphical marker on the map includes a menu selection enabling the user to activate the communicating of the information indicative of the selected location to the plurality of members of the online social network.

44. The method of claim 43 wherein the menu located on or next to the graphical marker on the map includes a menu selection enabling the user to set a desired meeting time for the event.

45. The method of claim 44, further comprising:
receiving information indicative of a selection by the user of the menu selection enabling the user to activate the communicating of the information indicative of the selected location, wherein the electronically communicating information indicative of the selected location to the plurality of members of the online social network is in response to the receiving the information indicative of the selection by the user of the menu selection enabling the user to activate the communicating of the information indicative of the selected location.

46. The method of claim 45, further comprising:
in response to receiving the information indicative of the selection by the user of the menu selection enabling the user to activate the communicating of the information indicative of the selected location, electronically communicating, by the at least one processor of the at least one machine for facilitating location-based social networks, the desired meeting time for the event to the plurality of members of the online social network.

47. The method of claim 31 wherein the information indicative of the selected location communicated to the plurality of members of the online social network includes directions to the selected location.

48. The method of claim 31 wherein the information indicative of the selected location communicated to the plurality of members of the online social network includes global positioning system (GPS) coordinates of the selected location.

49. The method of claim 31 wherein the information indicative of the selected location communicated to the plurality of members of the online social network includes a link which, when selected, activates one or more navigation systems to provide navigation particularly to the selected location for one or more of the plurality of members.

50. The method of claim 31 wherein the information indicative of the selected location communicated to the plurality of members of the online social network includes one or more of a written description of the event, a voice-recorded description of the event, and a video description of the event.

51. The method of claim 31 further comprising:
before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by enabling the user to indicate a point on the map indicative of the location on the map at which an event is to occur.

52. The method of claim 51 wherein the menu enabling the user to indicate a point on the map includes enabling the user to be able to touch a desired point on the map corresponding to the point on the map at which an event is to occur.

53. The method of claim 31 further comprising:
before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by providing an option to the user to indicate a selection to tie the location on the map at which an event is to occur to a current location of a device of the user; and
tying the location on the map at which an event is to occur to a current location of a device of the user based on the selection to tie the location on the map at which an event is to occur to the current location of the device of the user.

54. The method of claim 31 further comprising:
before the electronically receiving the information indicative of the location on the map selected by the user at which an event is to occur, electronically presenting on the graphical user interface, by at least one processor of the at least one machine for facilitating location-based social networks, a menu enabling the user to select the location on the map at which an event is to occur by enabling the user to indicate a point on the map by providing an option to the user to tie the location on the map at which an event is to occur to a current location of a particular device.

55. The method of claim 54 further comprising:
receiving updated information regarding the current location of the particular device; and
updating the location on the map at which an event is to occur substantially in real time as the updated information regarding the current location of the particular device is received.

56. A system for facilitating location-based social networks comprising:
at least one communications component of at least one machine for facilitating location-based social networks;
at least one processor coupled to the at least one communications component; and
at least one non-transitory computer-readable storage medium coupled to the at least one processor, the at least one non-transitory computer readable storage medium having computer executable instructions stored thereon that, when executed by the at least one processor, cause the at least one processor to:
electronically present to a user a map on a graphical user interface;
be able to electronically receive information indicative of a location on the map selected by the user at which an event is to occur; and
cause the at least one communications component to electronically communicate information indicative of the selected location to a plurality of members of an online social network.

57. The system of claim 56 wherein the computer executable instructions, when executed by the at least one processor, cause the at least one processor to:
cause the at least one communications component to electronically communicate the information indicative of the selected location to the plurality of members of the online social network is in response to the receiving of the information indicative of the location on the map selected by the user at which the event is to occur.

58. The system of claim 57, wherein the computer executable instructions, when executed by the at least one processor, further cause the at least one processor to:
select the plurality of members of the online social network to whom to communicate the information indicative of the location based on individual associations between the user and the plurality of members as defined in an account of the user on the online social network.

59. The system of claim 58 wherein the selecting the plurality of members includes:
determining members of the online social network who are friends of the user as defined in the account of the user on the online social network; and
electronically communicating the information indicative of the selected location to the members determined to be friends of the user.

60. A non-transitory computer-readable storage medium having computer-executable instructions stored thereon that, when executed by at least one processor of a computer system, cause the computer system to:
electronically present to a user a map on a graphical user interface;
be able to electronically receive information indicative of a location on the map selected by the user at which an event is to occur; and
cause the at least one communications component to electronically communicate information indicative of the selected location to a plurality of members of an online social network.

61. The non-transitory computer-readable storage medium of claim 60 wherein the computer executable instructions, when executed by the at least one processor, further cause the at least one processor to:
in response to the receiving the information indicative of the location on the map selected by the user at which the event is to occur, electronically present to the user, by at least one processor of the at least one machine for facilitating location-based social networks, a menu enabling the user to select the plurality of members of the online social network to whom the information indicative of the location is to be communicated.

62. The non-transitory computer-readable storage medium of claim 60 wherein the computer executable instructions, when executed by the at least one processor, further cause the at least one processor to:
electronically present on the map presented on the graphical user interface, by at least one processor of the at least one machine for facilitating location-based social networks, a graphical marker at a location on the map corresponding to the location on the map selected by the user at which the event is to occur.

63. The non-transitory computer-readable storage medium of claim 62 wherein the computer executable instructions, when executed by the at least one processor, further cause the at least one processor to:
be able to electronically receive information regarding current physical locations of a plurality of devices, each of the plurality of devices associated with a corresponding member of the plurality of members of the online social network to whom the information indicative of the location had been communicated; and
for each device of the plurality of devices, electronically present on the map presented on the graphical user interface a graphical marker at a location on the map corresponding to a current physical location of the device based on the received information regarding the current physical locations of the plurality of devices, the graphical marker representative of an online social network identity of the corresponding member of the online social network associated with the device.

64. A method performed by at least one machine for facilitating location-based social networks, the method comprising:
electronically receiving, by at least one processor of the at least one machine for facilitating location-based social networks, input from a user including selection criteria;
electronically determining, by at least one processor of the at least one machine for facilitating location-based social networks, one or more members of an online social network based on the selection criteria; and
in response to the electronically determining the one or more members of the online social network based on the selection criteria, for each of the determined one or more members, electronically presenting on a map presented on a graphical user interface, by at least one processor of the at least one machine for facilitating location-based social networks, an interactive graphical marker at a location on the map corresponding to a current physical location of a device associated with the member, the interactive graphical marker representative of an online social network identity of the member of the online social network.

65. The method of claim 64 wherein the selection criteria is based on voice recorded input from the user.

66. The method of claim 64 wherein the selection criteria includes one or more of: a name, online social network member identification, an email address, a phone number, online social network member profile information, likes of one or more members of the online social network, activities of one or more members of the online social network, events that one or more members of the online social network had attended, and interests of one or more members of the online social network.

67. The method of claim 64 wherein the selection criteria includes an inquiry input from the user and the determining the one or more members of the online social network based on the selection criteria includes determining the one or more members of the online social network based on determining which members of the online social network have input similar inquiries.

68. The method of claim 64, wherein the determining the one or more members of the online social network based on the selection criteria includes obtaining data originating from one or more online social network accounts on one or more other online social networks of the one or more users.

69. The method of claim 64, wherein the electronically determining one or more members of the online social network based on the selection criteria includes determining the one or more members of the online social network additionally based on individual associations between the user and the one or more of members as defined in an account of the user on the online social network.

70. A system for facilitating location-based social networks comprising:
at least one communications component of at least one machine for facilitating location-based social networks;
at least one processor coupled to the at least one communications component; and
at least one non-transitory computer-readable storage medium coupled to the at least one processor, the at least one non-transitory computer readable storage medium having computer executable instructions stored thereon that, when executed by the at least one processor, cause the at least one processor to:
be able to electronically receive input from a user including selection criteria;
electronically determine one or more members of an online social network based on the selection criteria; and
in response to the determination of the one or more members of the online social network based on the selection criteria, for each of the determined one or more members, electronically present on a map presented on a graphical user interface an interactive graphical marker at a location on the map corresponding to a current physical location of a device associated with the member, the interactive graphical marker representative of an online social network identity of the member of the online social network.

71. The system of claim 70 wherein the selection criteria includes an inquiry input from the user and the determining the one or more members of the online social network based on the selection criteria includes determining the one or more members of the online social network based on determining which members of the online social network have input similar inquiries.

72. The system of claim 70, wherein the determining the one or more members of the online social network based on the selection criteria includes obtaining data originating from one or more online social network accounts on one or more other online social networks of the one or more users.

73. The system of claim 70, wherein the electronically determining one or more members of the online social network based on the selection criteria includes determining the one or more members of the online social network additionally based on individual associations between the user and the one or more of members as defined in an account of the user on the online social network.

74. A non-transitory computer-readable storage medium having computer-executable instructions stored thereon that, when executed by at least one processor of a computer system, cause the computer system to:
be able to electronically receive input from a user including selection criteria;
electronically determine one or more members of an online social network based on the selection criteria; and
in response to the determination of the one or more members of the online social network based on the selection criteria, for each of the determined one or more members, electronically present on a map presented on a graphical user interface an interactive graphical marker at a location on the map corresponding to a current physical location of a device associated with the member, the interactive graphical marker representative of an online social network identity of the member of the online social network.

75. The non-transitory computer-readable storage medium of claim 74 wherein the selection criteria includes an inquiry input from the user and the determining the one or more members of the online social network based on the selection criteria includes determining the one or more members of the online social network based on determining which members of the online social network have input similar inquiries.

76. The non-transitory computer-readable storage medium of claim 74, wherein the determining the one or more members of the online social network based on the selection criteria includes obtaining data originating from one or more online social network accounts on one or more other online social networks of the one or more users.

77. The non-transitory computer-readable storage medium of claim 74, wherein the electronically determining one or more members of the online social network based on the selection criteria includes determining the one or more members of the online social network additionally based on individual associations between the user and the one or more of members as defined in an account of the user on the online social network.

78. A method performed by at least one machine for facilitating location-based social networks, the method comprising:
electronically obtaining, by at least one processor of the at least one machine for facilitating location-based social networks, information regarding one or more social network accounts of a first member of an online social network;
electronically obtaining, by at least one processor of the at least one machine for facilitating location-based social networks, information regarding one or more social network accounts of one or more other members of the online social network;
electronically comparing, by at least one processor of the at least one machine for facilitating location-based social networks, the information regarding the one or more social network accounts of the first member of the online social network and the information regarding the one or more social network accounts of the one or more other members of the online social network;
electronically associating, by at least one processor of the at least one machine for facilitating location-based social networks, the first member of the online social network with one of the one or more other members of the online social network based on the comparison;
electronically selecting, by at least one processor of the at least one machine for facilitating location-based social networks, a physical location for the first member of the online social network and the one of the one or more other members of the online social network to meet at; and
electronically communicating, by the at least one processor of the at least one machine for facilitating location-based social networks, information indicative of the selected location to the first member of the online social network and to the one of the one or more other members of the online social network.

79. The method of claim 78 wherein the electronically communicating information indicative of the selected location includes:
causing a presentation on a map on a graphical user interface, by at least one processor of the at least one machine for facilitating location-based social networks, a graphical marker at a location on the map corresponding to the selected location.

80. The method of claim 78 wherein the information indicative of the selected location includes global positioning system (GPS) coordinates of the selected location.

81. The method of claim 78 wherein the information indicative of the selected location includes a link which, when selected, activates one or more navigation systems to provide navigation particularly to the selected location for the first member of the online social network and the one of the one or more other members of the online social network.

82. The method of claim 78 further comprising:
electronically communicating, by the at least one processor of the at least one machine for facilitating location-based social networks, information indicative of one or more alternative physical meeting locations to at least one of the first member of the online social network and to the one of the one or more other members of the online social network;
receiving, by the at least one processor of the at least one machine for facilitating location-based social networks, an indication of a selected alternative physical meeting location of the one or more alternative physical meeting locations; and
electronically communicating, by the at least one processor of the at least one machine for facilitating location-based social networks, information indicative of the selected location to the first member of the online social network and to the one of the one or more other members of the online social network.

83. The method of claim 78 wherein the electronically selecting the physical location for the first member of the online social network and the one of the one or more other members of the online social network to meet is based on current physical locations of the first member of the online social network and the one of the one or more other members of the online social network.

84. The method of claim 78 wherein the electronically selecting the physical location for the first member of the online social network and the one of the one or more other members of the online social network to meet is based on compensation received for selection of one or more locations.

85. The method of claim 78 wherein the electronically selecting the physical location for the first member of the online social network and the one of the one or more other members of the online social network to meet is based on the comparing of the information regarding the one or more social network accounts of the first member of the online social network and the information regarding the one or more social network accounts of the one or more other members of the online social network, wherein the comparing includes comparing one or more of: online social network member profile information, likes of one or more members of the online social network, activities of one or more members of the online social network, events that one or more members of the online social network had attended, and interests of one or more members of the online social network.

86. A system for facilitating location-based social networks comprising:
at least one communications component of at least one machine for facilitating location-based social networks;
at least one processor coupled to the at least one communications component; and
at least one non-transitory computer-readable storage medium coupled to the at least one processor, the at least one non-transitory computer readable storage medium having computer executable instructions stored thereon that, when executed by the at least one processor, cause the at least one processor to:
electronically obtain information regarding one or more social network accounts of a first member of an online social network;
electronically obtain information regarding one or more social network accounts of one or more other members of the online social network;
electronically compare the information regarding the one or more social network accounts of the first member of the online social network and the information regarding the one or more social network accounts of the one or more other members of the online social network;
electronically associate the first member of the online social network with one of the one or more other members of the online social network based on the comparison;
electronically select a physical location for the first member of the online social network and the one of the one or more other members of the online social network to meet at; and
electronically communicate information indicative of the selected location to the first member of the online social network and to the one of the one or more other members of the online social network.

87. The system of claim 86 wherein the electronically communicating information indicative of the selected location includes:
causing presentation on a map on a graphical user interface of a graphical marker at a location on the map corresponding to the selected location.

88. The system of claim 86 wherein the information indicative of the selected location includes global positioning system (GPS) coordinates of the selected location.

89. A non-transitory computer-readable storage medium having computer-executable instructions stored thereon that, when executed by at least one processor of a computer system, cause the computer system to:
electronically obtain information regarding one or more social network accounts of a first member of an online social network;
electronically obtain information regarding one or more social network accounts of one or more other members of the online social network;
electronically compare the information regarding the one or more social network accounts of the first member of the online social network and the information regarding the one or more social network accounts of the one or more other members of the online social network;
electronically associate the first member of the online social network with one of the one or more other members of the online social network based on the comparison;
electronically select a physical location for the first member of the online social network and the one of the one or more other members of the online social network to meet at; and
electronically communicate information indicative of the selected location to the first member of the online social network and to the one of the one or more other members of the online social network.

90. The non-transitory computer-readable storage medium of claim 89 wherein the electronically communicating information indicative of the selected location includes:
causing a presentation on a map on a graphical user interface a graphical marker at a location on the map corresponding to the selected location.

91. The non-transitory computer-readable storage medium of claim 89 wherein the information indicative of the selected location includes global positioning system (GPS) coordinates of the selected location.

92. A method performed by at least one machine for facilitating location-based social networks, the method comprising:
electronically receiving, by at least one communications component of the at least one machine for facilitating location-based social networks, information regarding current physical locations of a plurality of devices, each of the plurality of devices associated with a corresponding one of a plurality of members of an online social network;
electronically presenting, by at least one processor of the at least one machine for facilitating location-based social networks, a map on a graphical user interface; and
for each of the plurality of devices:
electronically presenting on the map presented on the graphical user interface, by at least one processor of the at least one machine for facilitating location-based social networks, an interactive graphical marker at a location on the map corresponding to a current physical location of the device based on the received information regarding the current physical locations of the plurality of devices, the graphical marker representative of an online social network identity of the corresponding member of the online social network; and
moving, by at least one processor of the at least one machine for facilitating location-based social networks, the interactive marker on the map presented on the graphical user interface based on corresponding updated information received by the at least one communications component regarding a new current physical location of the device.

93. The method of claim 92, further comprising:
electronically executing, by at least one processor of the at least one machine for facilitating location-based social networks, at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network.

94. The method of claim 93, wherein the corresponding updated information received by the at least one communications component is based on global positioning system (GPS) information regarding current physical locations of the plurality of devices.

95. The method of claim 92 wherein each device of the plurality of devices is a mobile device.

96. The method of claim 92 wherein the plurality of members of the online social network is a subset of all current members of the online social network.

97. A system for facilitating location-based social networks comprising:
at least one communications component of at least one machine for facilitating location-based social networks;
at least one processor coupled to the at least one communications component; and
at least one non-transitory computer-readable storage medium coupled to the at least one processor, the at least one non-transitory computer readable storage medium having computer executable instructions stored thereon that, when executed by the at least one processor, cause the at least one processor to:
be able to electronically receive information regarding current physical locations of a plurality of devices, each of the plurality of devices associated with a corresponding one of a plurality of members of an online social network;
electronically present a map on a graphical user interface; and
for each of the plurality of devices:
electronically present on the map presented on the graphical user interface an interactive graphical marker at a location on the map corresponding to a current physical location of the device based on the received information regarding the current physical locations of the plurality of devices, the graphical marker representative of an online social network identity of the corresponding member of the online social network; and
move the interactive marker on the map presented on the graphical user interface in substantially real time as corresponding updated information is received by the at least one communications component regarding a new current physical location of the device, wherein the interactive marker is displayed on the map as the interactive marker moves.

98. The system of claim 97, wherein the computer executable instructions, when executed by the at least one processor, further cause the at least one processor to:
electronically execute at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network.

99. The system of claim 98, wherein the received corresponding updated information is based on global positioning system (GPS) information regarding current physical locations of the plurality of devices.

100. The system of claim 97 wherein each device of the plurality of devices is a mobile device.

101. A non-transitory computer-readable storage medium having computer-executable instructions stored thereon that, when executed by at least one processor of a computer system, cause the computer system to:
be able to receive information regarding current physical locations of a plurality of devices, each device of the plurality of devices associated with a corresponding one of a plurality of members of an online social network;
present a map on a graphical user interface; and
for each of the plurality of devices:
present on the map presented on the graphical user interface a graphical marker at a location on the map corresponding to a current physical location of the device based on the received information regarding the current physical locations of the plurality of devices, the graphical marker representative of an online social network identity of the corresponding member of the online social network; and
move the graphical marker on the map presented on the graphical user interface as corresponding updated information is received regarding a new current physical location of the device.

102. The non-transitory computer-readable storage medium of claim 101, wherein the computer executable instructions, when executed by the at least one processor, further cause the computer system to:
electronically execute at least a portion of an online game including the plurality of members of the online social network as players wherein the game has rules based on a physical proximity, as depicted on the map, of one or more of the plurality of devices of one or more of the plurality of members of the online social network to one or more other devices of the plurality of devices of one or more other members of the plurality of members of the online social network.

103. The non-transitory computer-readable storage medium of claim 102, wherein the received corresponding updated information is based on global positioning system (GPS) information regarding current physical locations of the plurality of devices.

104. The non-transitory computer-readable storage medium of claim 101 wherein each device of the plurality of devices is a mobile device.

105. The non-transitory computer-readable storage medium of claim 101, wherein the computer executable instructions, when executed by the at least one processor, further cause the computer system to:
present on the map a marker expandable by a user; and
be able to receive input indicative of expansion or contraction of the marker by the user;
expand or contract the marker on the map according to the received input indicative of expansion or contraction; and
broadcast a message to each member of the online social network for which an associated graphical marker representative of the online social network identity of the member is on the map and falls within the marker.

106. The non-transitory computer-readable storage medium of claim 101, wherein the marker expandable by the user is a circular or rectangular.

107. The non-transitory computer-readable storage medium of claim 101, wherein the computer executable instructions, when executed by the at least one processor, further cause the computer system to:
present on the graphical user interface a matrix of profile images each representative of an online social network identity of a member of the online social network associated with the user;
be able to receive input indicative of selection by the user of one or more of the profile images in the matrix; and
cause communication to occur with each member of the online social network for which the one or more of the profile images in the matrix was selected based on the received input indicative of the selection by the user of the one or more of the profile images in the matrix.

108. The non-transitory computer-readable storage medium of claim 101, wherein the computer executable instructions, when executed by the at least one processor, further cause the computer system to:
be able to receive input indicative of selection regarding a visibility setting; and
set a preference regarding whether a graphical marker presentable at a location on a map on a graphical user interfaces of devices of other members of the online social network is to be presented on the map on the graphical user interfaces of devices of the one or more other members of the online social network based on one or more criteria.

109. The non-transitory computer-readable storage medium of claim 108 wherein the one or more criteria is regarding one or more of: a threshold distance between a device of the user and the devices of the one or more members of the online social network; an association between the one or more members of the online social network and the user as defined in a user account of the user of the online social network; and a reciprocal preference setting regarding visibility as defined in a user account of the one or more members of the online social network.

110. The non-transitory computer-readable storage medium of claim 101, wherein the computer executable instructions, when executed by the at least one processor, further cause the computer system to:
provide a notification to the user when one or more other members of the online social network associated with the user is within a particular distance from the user; and
communicate to the user information indicative of a suggested location at which the user and the one or more other members associated with the user can meet.

111. The non-transitory computer-readable storage medium of claim 101 wherein the communicating to the user information indicative of a suggested location includes:
presenting on the map presented on the graphical user interface a graphical marker at a location on the map corresponding to the suggested location.

112. The non-transitory computer-readable storage medium of claim 101, wherein the computer executable instructions, when executed by the at least one processor, further cause the computer system to:
communicate to the user an incentive to go to the suggested location.

113. The non-transitory computer-readable storage medium of claim 101, wherein the computer executable instructions, when executed by the at least one processor, further cause the computer system to:
be able to receive input indicative of a selection by the user to follow a selected member of the online social network for which a graphical marker is displayed at a location on the map corresponding to a current physical location of a device of the selected member; and
move the map on the graphical user interface to make the graphical marker displayed at the location on the map corresponding to the current physical location of the device of the selected member stay in view on the graphical user interface substantially in real time as updated information is received regarding a new current physical location of the device of the selected member of the online social network.

114. The non-transitory computer-readable storage medium of claim 101, wherein the computer executable instructions, when executed by the at least one processor, further cause the computer system to:
receive information indicative of a location on the map selected by a user at which an event is to occur; and
in response to receiving the information indicative of the location, communicate information indicative of the selected location to the plurality of members of the online social network.

115. The non-transitory computer-readable storage medium of claim 101, wherein the computer executable instructions, when executed by the at least one processor, further cause the computer system to:
be able to receive user input indicative of a marking to be made on the map;
present on the map a marking corresponding to the input indicative of the marking to be made on the map; and
communicate information regarding the marking to enable corresponding markings to be presented on corresponding maps on graphical user interfaces of devices of one or more of the plurality of members of the online social network.
